(19) United States
(12) Patent Application Publication
(10) Pub. No.: US 2021/0004909 A1
(43) Pub. Date: Jan. 7, 2021

(54) SYSTEMS AND METHODS FOR REAL-TIME ACCIDENT ANALYSIS

(71) Applicant: The Travelers Indemnity Company, Hartford, CT (US)

(72) Inventors: Michael Farmer, Charlotte, NC (US); Brandon G. Roope, Charlotte, NC (US); Mark A. Gajdosik, South Boston, MA (US); Patrick A. Skiba, Plainville, CT (US); William J. Caneira, Storrs, CT (US); Andrew S. Breja, Hamden, CT (US)

(21) Appl. No.: 16/459,390

(22) Filed: Jul. 1, 2019

(51) Int. Cl. G06Q 40/08; G10L 13/04; G06Q 10/10; H04W 4/029; G06T 17/30

(52) U.S. Cl. CPC G06Q 40/08; G10L 13/043; G06T 17/30; H04W 4/029; G06Q 10/10

(57) ABSTRACT

Systems and methods for real-time accident analysis that provide for in-process user guidance for incident image documentation, recorded statements, and user-drawn scene diagramming via a mobile device GUI vector and map-based drawing tool.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Car accidents in the United States average around six million (6 million) per year¹ and result in approximately twenty-seven and a half billion dollars ($27.5 billion) in claimed insurance collision losses alone, annually². With so much liability and insurance exposure at stake, processes for managing accidents, as well as for accurately reporting and analyzing insurance claims resulting therefrom can be extremely advantageous. Existing on-board crash detection systems assist in expediting the summoning of emergency services to an accident scene, for example, and applications that allow insurance customers to submit digital photos of damage to an insurance company facilitate expedited claims processing. Such systems however, have failed to provide advantages that simplified, accurate, and/or more complete claim reporting could provide. ¹ For 2015, estimated at six million two hundred and ninety-six thousand (6,296,000) police-reported traffic crashes by the National Highway Transportation and Safety Administration (NHTSA), U.S. Department of Transportation: https://crashstats.nhtsa.dot.gov/Api/Public/ViewPublications/812376.² The Auto Insurance Database Report (2012/2013) published by the National Association of Insurance Commissioners, at pg. 176: http://www.naic.org/documents/prod_serv_statistical_aut_pb.pdf.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a perspective diagram of a system according to some embodiments;

FIG. 3 is a perspective diagram of a system according to some embodiments;

FIG. 4 is a flow diagram of a method according to some embodiments;

FIG. 5A, FIG. 5B, FIG. 5C, and FIG. 5D are diagrams of a system depicting example interfaces according to some embodiments;

FIG. 6 is a block diagram of an apparatus according to some embodiments; and

FIG. 7A, FIG. 7B, FIG. 7C, FIG. 7D, and FIG. 7E are perspective diagrams of exemplary data storage devices according to some embodiments.

### DETAILED DESCRIPTION

### I. Introduction

Due to the high volume and great costs arising from automobile (and other vehicle or object, e.g., home and/or business) accidents every year, the number of insurance claims that require processing is a critical factor for insurance companies to manage. With the current average lag time between an accident occurrence and insurance claim initiation being approximately eight (8) hours, claim handling queues have been lengthened and important accident details may have been lost, forgotten, or overlooked by the time a claim is initiated. Any reduction in the lag time may accordingly be beneficial for reducing processing queues and/or reducing the likelihood of important details descriptive of the accident being lost. Preservation of accident details or evidence may also or alternatively benefit accident reconstruction and/or fault analysis procedures and/or legal investigations.

Previous claim process facilitation systems allow accident victims to submit digital photos of sustained damage, but do not guide an insured through the self-service image capture process or otherwise address reduction of claim processing lag times (particularly in the initial lag time of claim reporting). Accident-detection systems are primarily directed to mitigating injury and loss of life by expediting emergency services deployment, for example, but offer little or no post-emergency functionality.

In accordance with embodiments herein, these and other deficiencies of previous efforts are remedied by providing systems, apparatus, methods, and articles of manufacture for real-time accident analysis. In some embodiments, for example, an accident analysis system may employ a set of logical rules and/or procedures that are specially-coded to (i) detect and/or verify accident occurrences (e.g., auto, home, and/or business), (ii) automatically capture accident event evidence, (iii) provide structured prompts that guide an accident victim through post-emergency tasks and/or checklists (e.g., damage image capture, recorded statements, and/or accident/incident scene diagramming), and/or (iv) automatically analyze accident evidence to derive at least one accident result (e.g., an assignment of fault, blame, or liability and/or a determination regarding an insurance claim payment and/or payment amount). According to some embodiments, a real-time accident analysis system may provide input guidance to and/or receive input from an insured (and/or other user) and utilize the data to construct a virtual representation of the accident scene and/or to analyze the accident event (e.g., to derive an accident result).

As utilized herein, the term “accident result” may generally refer to any conclusion and/or determination that is defined and/or derived based on an analysis of accident data and/or evidence. With respect to legal liability (criminal and/or civil), fault, and/or blame, for example, an accident result may comprise an estimate and/or calculation of assigned responsibility (e.g., causation) for the accident event. In the case of an insurance claim for the accident event, an accident result may comprise a determination and/or decision regarding whether the claim will be paid or not (e.g., based on an assignment or “result” determined regarding liability or responsibility), and/or a determination regarding how much will be paid (e.g., based on an estimated amount of damage, coverage limits, etc.).

### II. Real-Time Accident Analysis Systems

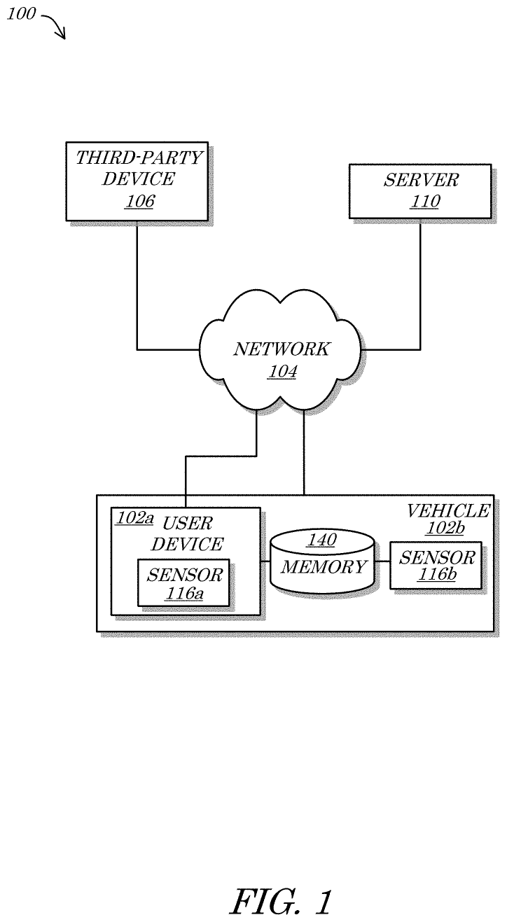

Referring first to FIG. 1, a block diagram of a system 100 according to some embodiments is shown. In some embodiments, the system 100 may comprise a user device 102a that may be located within (as depicted in FIG. 1) or proximate to a vehicle 102b (or, in some cases, the vehicle 102b may comprise a building or structure, such as a home or office). In some embodiments, the user device 102a and/or the vehicle 102b may be in communication, via a network 104, with one or more remote devices, such as a third-party device 106 and/or a server 110. According to some embodiments, the system 100 may comprise one or more sensors 116a-b. As depicted in FIG. 1, for example, the user device 102a may comprise (and/or be in communication with) a first sensor 116a and/or the vehicle 102b may comprise (and/or be in communication with) a second sensor 116b. In some embodiments, the system 100 may comprise a memory 140. As depicted in FIG. 1, in some embodiments the memory 140 may be disposed in and/or be coupled to the vehicle 102b. According to some embodiments, the memory 140 may also or alternatively be part of the user device 102a, the network 104, the third-party device 106, the server 110, and/or may comprise a stand-alone and/or networked data storage device, such as a solid-state and/or non-volatile memory card (e.g., a Secure Digital (SD) card such as an SD Standard-Capacity (SDSC), an SD High-Capacity (SDHC), and/or an SD eXtended-Capacity (SDXC) and any various practicable form-factors, such as original, mini, and micro sizes, such as are available from Western Digital Corporation of San Jose, Calif.). In some embodiments, the memory 140 may be in communication with and/or store data from one or more of the sensors 116a-b. As depicted in FIG. 1, any or all of the devices 102a-b, 106, 110, 116a-b, 140 (or any combinations thereof) may be in communication via the network 104.

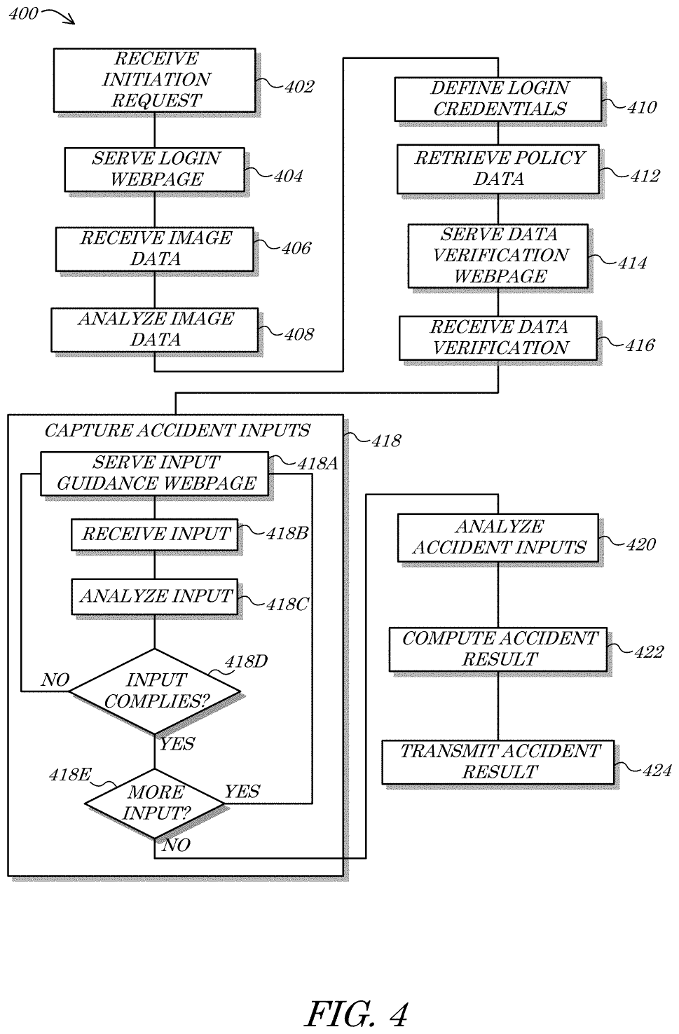

Fewer or more components 102a-b, 104, 106, 110, 116a-b, 140 and/or various configurations of the depicted components 102a-b, 104, 106, 110, 116a-b, 140 may be included in the system 100 without deviating from the scope of embodiments described herein. In some embodiments, the components 102a-b, 104, 106, 110, 116a-b, 140 may be similar in configuration and/or functionality to similarly named and/or numbered components as described herein. In some embodiments, the system 100 (and/or portion thereof) may comprise an automatic accident analysis program, system, and/or platform programmed and/or otherwise configured to execute, conduct, and/or facilitate the method 400 of FIG. 4 herein, and/or portions thereof.

The user device 102a, in some embodiments, may comprise any type or configuration of computing, mobile electronic, network, user, and/or communication device that is or becomes known or practicable. The user device 102a may, for example, comprise one or more tablet computers, such as an iPad® manufactured by Apple®, Inc. of Cupertino, Calif., and/or cellular and/or wireless telephones or “smart” phones, such as an iPhone® (also manufactured by Apple®, Inc.) or an Optimus™ S smart phone manufactured by LG® Electronics, Inc. of San Diego, Calif., and running the Android® operating system from Google®, Inc. of Mountain View, Calif. In some embodiments, the user device 102a may comprise one or more devices owned and/or operated by one or more users, such as an automobile (and/or other vehicle, liability, personal, and/or corporate insurance customer) insurance customer (e.g., insured) and/or other accident victim and/or witness. According to some embodiments, the user device 102a may communicate with the server 110 via the network 104 to provide evidence and/or other data descriptive of an accident event and/or accident scene (e.g., captured images of damage incurred, recorded statements, and/or scene diagram(s)), as described herein. According to some embodiments, the user device 102a may store and/or execute specially programmed instructions (such as a mobile device application) to operate in accordance with embodiments described herein. The user device 102a may, for example, execute one or more mobile device programs that activate and/or control the first sensor 116a and/or the second sensor 116b to acquire accident-related data therefrom (e.g., accelerometer readings in the case that the first sensor 116a comprises an accelerometer of the user device 102a, recorded statement data in the case that the first sensor 116a comprises a microphone, scene diagram data in the case that the first sensor 116a comprises a touch-screen input mechanism, and/or bird's-eye view imagery/video in the case that the second sensor comprises a camera array of the vehicle 102b).

According to some embodiments, the vehicle 102b may comprise any type, configuration, style, and/or number of vehicles (or other objects or structures), such as, but not limited to, passenger automobiles (e.g., sedans, sports cars, Sports Utility Vehicles (SUVs), pickup trucks), trucks, vans, buses, tractors, construction equipment, agricultural equipment, airplanes, boats, and trains. In some embodiments, the vehicle 102b may comprise an automobile owned and/or operated by a user (not shown) that also owns and/or operates the user device 102a. According to some embodiments, the vehicle 102b may comprise the second sensor 116b, such as a proximity sensor, a global positioning sensor, an oxygen sensor, a traction sensor, an airbag sensor, a crash/impact sensor, a keyless-entry sensor, a tire pressure sensor, an optical sensor (such as a light sensor, a camera, or an Infrared Radiation (IR) sensor), and/or a Radio Frequency (RF) sensor (e.g., a Bluetooth® transceiver, and inductive field sensor, and/or a cellular or other signal sensor). In some embodiments, the second sensor 116b may comprise a “360°” or bird's-eye camera array and/or system, as described herein.

The network 104 may, according to some embodiments, comprise a Local Area Network (LAN; wireless and/or wired), cellular telephone, Bluetooth® and/or Bluetooth Low Energy (BLE), Near Field Communication (NFC), and/or Radio Frequency (RF) network with communication links between the server 110, the user device 102a, the vehicle 102b, the third-party device 106, the sensors 116a-b, and/or the memory 140. In some embodiments, the network 104 may comprise direct communications links between any or all of the components 102a-b, 106, 110, 116a-b, 140 of the system 100. The user device 102a may, for example, be directly interfaced or connected to one or more of the vehicle 102b and/or the controller device 110 via one or more wires, cables, wireless links, and/or other network components, such network components (e.g., communication links) comprising portions of the network 104. In some embodiments, the network 104 may comprise one or many other links or network components other than those depicted in FIG. 1. The user device 102a may, for example, be connected to the server 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-b, 106, 110, 116a-b, 140 of the system 100. The network 104 may comprise one or more cellular telephone networks with communication links between the user device 102a, the vehicle 102b, and the server 110, for example, and/or may comprise a BLE, NFC, and/or “personal” network comprising short-range wireless communications between the user device 102a and the vehicle 102b, for example.

The third-party device 106, in some embodiments, may comprise any type or configuration of a computerized processing device, such as a PC, laptop computer, computer server, database system, and/or other electronic device, devices, or any combination thereof. In some embodiments, the third-party device 106 may be owned and/or operated by a third-party (i.e., an entity different than any entity owning and/or operating any of the user device 102a, the vehicle 102b, and/or the server 110). The third-party device 106 may, for example, be owned and/or operated by a data and/or data service provider, such as Dun & Bradstreet® Credibility Corporation (and/or a subsidiary thereof, such as Hoovers™), Deloitte® Development, LLC, Experian™ Information Solutions, Inc., and/or Edmunds.com®, Inc. In some embodiments, the third-party device 106 may supply and/or provide data, such as location data, encryption/decryption data, configuration data, and/or preference data to the server 110, the user device 102a, the vehicle 102b, and/or the sensors 116a-b. In some embodiments, the third-party device 106 may comprise a plurality of devices and/or may be associated with a plurality of third-party entities. According to some embodiments, the third-party device 106 may comprise the memory 140 (or a portion thereof), such as in the case the third-party device 106 comprises a third-party data storage service, device, and/or system, such as the Amazon® Simple Storage Service (Amazon® S3™) available from Amazon.com, Inc. of Seattle, Wash. or an open-source third-party database service, such as MongoDB™ available from MongoDB, Inc. of New York, N.Y.

In some embodiments, the server 110 may comprise an electronic and/or computerized controller device, such as a computer server and/or server cluster communicatively coupled to interface with the user device 102a and/or the vehicle 102b (directly and/or indirectly). The server 110 may, for example, comprise one or more PowerEdge™ M910 blade servers manufactured by Dell®, Inc. of Round Rock, Tex., which may include one or more Eight-Core Intel® Xeon® 7500 Series electronic processing devices. According to some embodiments, the server 110 may be located remotely from one or more of the user device 102a and the vehicle 102b. The server 110 may also or alternatively comprise a plurality of electronic processing devices located at one or more various sites and/or locations (e.g., a distributed computing and/or processing network).

According to some embodiments, the server 110 may store and/or execute specially-programmed instructions to operate in accordance with embodiments described herein. The server 110 may, for example, execute one or more programs that facilitate and/or cause the automatic detection, verification, credentialing/authentication, data capture, data capture guidance, and/or data analysis of an accident event, as described herein. According to some embodiments, the server 110 may comprise a computerized processing device, such as a PC, laptop computer, computer server, and/or other network or electronic device, operated to manage and/or facilitate automatic accident analysis in accordance with embodiments described herein.

According to some embodiments, the sensors 116a-b may comprise any type, configuration, and/or quantity of sensor devices that are or become known or practicable. In some embodiments, the first sensor 116a may comprise an accelerometer, gyroscope, locational positioning device, image, audio, and/or video capture and/or recording device of the user device 102a (e.g., a “smart” phone). According to some embodiments, the second sensor 116b may comprise various vehicle sensors, such as brake sensors, tire pressure sensors, temperature sensors, locational positioning devices, door sensors, and/or one or more cameras, such as a backup camera, an interior/cabin/passenger camera, and/or a camera array, such as a bird's-eye or “360°” view array. The second sensor 116b may, in some embodiments, be integrated into the vehicle 102b as Original Equipment Manufacturer (OEM) devices installed in the vehicle 102b during the manufacture thereof. In some embodiments, the second sensor 116b may comprise an after-market sensor and/or sensor system, such as a Vacron 360° Dash Camera having a single four (4) lens camera and available from the Fuho Technology Company, Ltd. of Shen Zhen, China or a Wiseup™ Car Vehicle 360 Degree Panoramic View System having four (4) separately mounted and interconnected cameras and available from the Shenzhen Dawu Times Technology Co., Ltd. of Shen Zhen, China.

In some embodiments, the server 110, the third-party device 106, the sensors 116a-b, the user device 102a, and/or the vehicle 102b may be in communication with the memory 140. The memory 140 may store, for example, mobile device application data, vehicle data, data capture guidance information/rules, user/driver data, sensor data, location data (such as coordinates, distances, etc.), security access protocol and/or verification data, and/or instructions that cause various devices (e.g., the server 110, the third-party device 106, the user device 102a, and/or the vehicle 102b) to operate in accordance with embodiments described herein. In some embodiments, the memory 140 may comprise any type, configuration, and/or quantity of data storage devices that are or become known or practicable. The memory 140 may, for example, comprise an array of optical and/or solid-state hard drives configured to store user identifier, vehicle identifier, device identifier, and/or location data provided by (and/or requested by) the user device 102a and/or the server 110, and/or various operating instructions, drivers, etc. While the memory 140 is depicted as a stand-alone component of the system 100 in FIG. 1, the memory 140 may comprise multiple components. In some embodiments, a multi-component memory 140 may be distributed across various devices and/or may comprise remotely dispersed components. Any or all of the user device 102a, the vehicle 102b, the third-party device 106, and/or the server 110 may comprise the memory 140 or a portion thereof, for example, and/or one or more of the sensors 116a-b may comprise the memory 140 or a portion thereof.

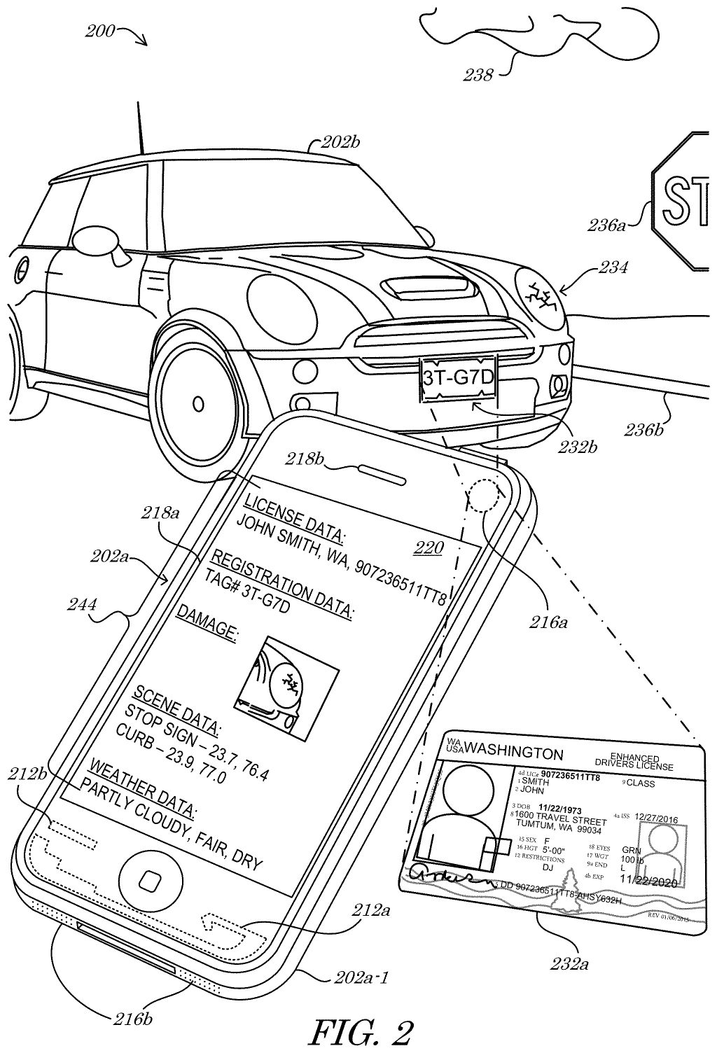

Turning to FIG. 2, a perspective diagram of system 200, according to some embodiments, is shown. In some embodiments, the system 200 may comprise a mobile electronic device 202a and/or a vehicle 202b (or other object or structure). In some embodiments, the mobile electronic device 202a may comprise a housing 202a-1 that retains, houses, and/or is otherwise coupled to communication antenna 212a-b (e.g., a first antenna 212a, such as a cellular network or long-range antenna, and/or a second antenna 212b, such as a Wi-Fi®, Bluetooth®, and/or other short-range antenna), input devices 216a-b (e.g., a first input device 216a, such as a camera and/or a second input device 216b, such as a microphone), and/or output devices 218a-b (e.g., a first output device 218a, such as a display screen (e.g., touch-sensitive interface), and/or a second output device 218b, such as a speaker). According to some embodiments, the mobile electronic device 202a (and/or the display screen 218a thereof) may output a GUI 220 that provides output from and/or accepts input for, a mobile device application executed by the mobile electronic device 202a.

In some embodiments, the mobile electronic device 202a (and/or the input devices 216a-b thereof) may capture, sense, record, and/or be triggered by objects, data, and/or signals at or near an accident scene (e.g., the depicted setting of the system 200 in FIG. 2). The camera 216a of the mobile electronic device 202a may, for example, capture images (e.g., in response to image capture guidance and/or rules) of one or more textual indicia 232a-b within visual proximity to the mobile electronic device 202a. At the accident scene, for example, the camera 216a may capture an image (and/or video) of an identification card, such as the depicted vehicle operator's license 232a (e.g., a driver's license and/or other identification card, such as an insurance card), and/or an identifier of the vehicle 202b, such as the depicted license plate number 232b (e.g., a Vehicle Identification Number (VIN), make, model, and/or other human or computer-readable indicia).

According to some embodiments, the camera 216a may capture image data of damage 234 (e.g., in response to image capture guidance and/or rules) to the vehicle 202b (and/or other object), roadway features 236a-b, such as road signs 236a (and/or other roadway instructions and/or guidance objects or devices) and/or curbs 236b (e.g., roadway edges, centerlines, lanes, etc.), and/or environmental conditions 238 (e.g., cloud cover, rain, puddles, snow). In some embodiments, other input devices 216a-b and/or sensors (not separately depicted in FIG. 2) may also or alternatively capture data from the accident scene. The microphone 216b may, for example, capture sound (e.g., in response to sound/recorded statement capture guidance and/or rules) information indicative of a recorded statement and/or environmental conditions 238 such as rainfall, sounds of cars passing through puddles, sounds of vehicles traveling over gravel, etc. In some embodiments, captured data may be in the form of electronic signals, signal detection, signal strength readings, and/or signal triangulation data. The short-range antenna 212b may detect, measure, and/or triangulate, for example, one or more signals from the vehicle 202b, the road sign 236a (e.g., an RF-enabled roadway device), and/or other devices, such as a second mobile electronic device (not shown), e.g., located within the vehicle 202b and broadcasting a short-range communications discovery signal (such as a Bluetooth® discovery signal). According to some embodiments, the mobile electronic device 202a may communicate wirelessly (e.g., via the short-range antenna 212b) with the vehicle 202b to acquire (e.g., query) sensor data of the vehicle stored in an electronic storage device (not shown in FIG. 2) therein.

In some embodiments, any or all information captured, recorded, and/or sensed at, near, and/or otherwise descriptive of the accident scene by the mobile electronic device 202a (and/or by the vehicle 202b) may be processed and/or analyzed. The data may be analyzed by an application executed by the mobile electronic device 202a, for example, and/or may be transmitted to a remote server (not shown in FIG. 2) that conducts data analysis routines. According to some embodiments, the data analysis may result in a definition of one or more textual and/or other human-readable data elements 244 that may be output to a user (not shown) via the GUI 220 generated on the display screen 218a. As depicted in FIG. 2, for example, the data elements 244 may comprise data from the operator's license 232a and/or the license plate number 232b may be optically recognized, converted into digital character information, and output via the GUI 220. In some embodiments, the GUI 220 may also or alternatively output data elements 244 comprising an image (e.g., a “thumbnail” image) of the damage 234, derived location information (e.g., based on spatial analysis of image data) for the road sign 236a and/or the curb 236b, and/or a textual description (e.g., a qualitative description) of the weather conditions 238. In some embodiments, the data elements 244 may be utilized to trigger and/or conduct various processes, such as the method 400 of FIG. 4 herein, and/or portions thereof. The data elements 244 may be utilized in conjunction with an application of stored rules, for example, to derive an accident result, such as a determination regarding causation of the accident, an estimate of damage caused by the accident, and/or a determination of whether (and/or how much) an insurance claim in response to the accident will be approved or denied.

In some embodiments, the mobile electronic device 202a may comprise a smart mobile phone, such as the iPhone® 8 or a later generation iPhone®, running iOS 10 or a later generation of iOS, supporting Location Services. The iPhone® and iOS are produced by Apple Inc., however, embodiments are not limited to any particular portable computing device or smart mobile phone. For example, the mobile electronic device 202a may take the form of a laptop computer, a handheld computer, a palm-size computer, a pocket computer, a palmtop computer, a Personal Digital Assistant (PDA), a tablet computer, an electronic organizer, a mobile phone, a portable/mobile phone, a feature phone, a smartphone, a tablet, a portable/mobile data terminal, an iPhone®, an iPad®, an iPod®, an Apple® Watch (or other “smart” watch), and other portable form-factor devices by any vendor containing at least one Central Processing Unit (CPU) and a wireless communication device (e.g., the communication antenna 212a-b).

According to some embodiments, the mobile electronic device 202a runs (i.e., executes) a mobile device software application (“app”) that causes the generation and/or output of the GUI 220. In some embodiments, the app works with Location Services supported by an iOS operating system executing on the mobile electronic device 202a. The app may include, comprise, and/or cause the generation of the GUI 220, which may be utilized, for example, for transmitting and/or exchanging data through and/or via a network (not shown in FIG. 2; e.g., the Internet). In some embodiments, once the app receives captured data from an input device 216a-b, the app in turn transmits the captured data through a first interface for exchanging data (not separately depicted in FIG. 2) and through the network. The network may, in some embodiments, route the data out through a second interface for exchanging data (not shown) to a remote server. According to some embodiments, the app includes specially-programmed software code that includes one or more address identifiers such as Uniform Resource Locator (URL) addresses, Internet Protocol (IP) address, etc., that point to and/or reference the server.

Fewer or more components 202a-b, 202a-1, 212a-b, 216a-b, 218a-b, 220, 232a-b, 234, 236a-b, 238, 244 and/or various configurations of the depicted components 202a-b, 202a-1, 212a-b, 216a-b, 218a-b, 220, 232a-b, 234, 236a-b, 238, 244 may be included in the system 200 without deviating from the scope of embodiments described herein. In some embodiments, the components 202a-b, 202a-1, 212a-b, 216a-b, 218a-b, 220, 232a-b, 234, 236a-b, 238, 244 may be similar in configuration and/or functionality to similarly named and/or numbered components as described herein. In some embodiments, the system 200 (and/or portion thereof) may comprise an automatic accident analysis program, system, and/or platform programmed and/or otherwise configured to execute, conduct, and/or facilitate the method 400 of FIG. 4 herein, and/or portions thereof.

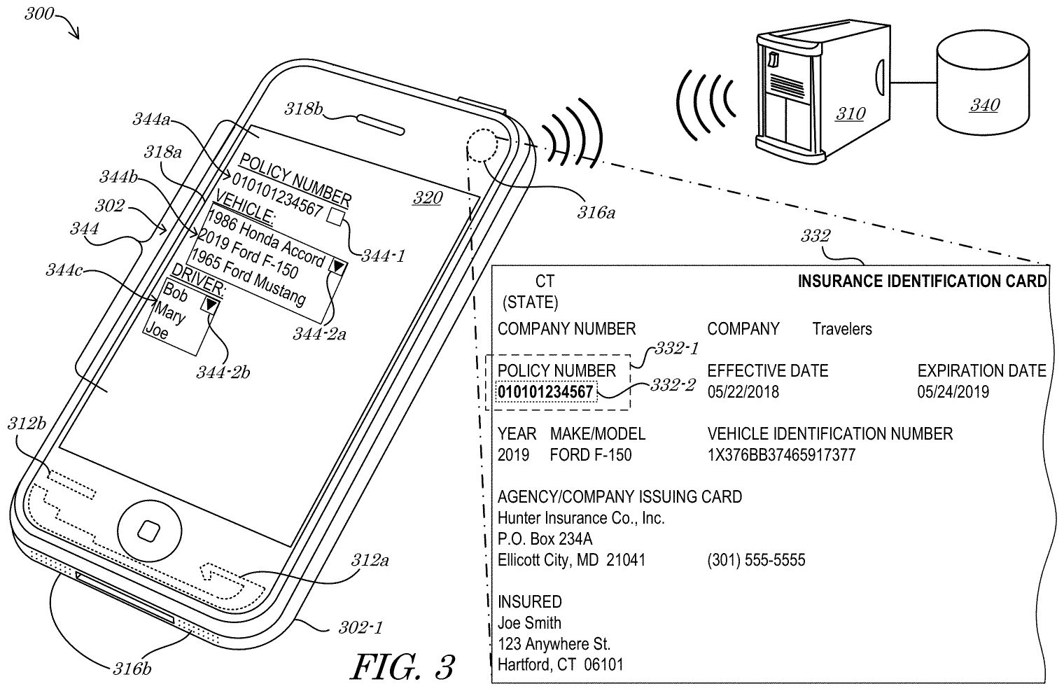

Referring now to FIG. 3, a perspective diagram of system 300, according to some embodiments, is shown. In some embodiments, the system 300 may comprise a mobile electronic device 302 in communication with a server 310 (e.g., a webserver, data processing server, and/or data storage server). In some embodiments, the mobile electronic device 302 may comprise a housing 302-1 that retains, houses, and/or is otherwise coupled to communication antenna 312a-b (e.g., a first antenna 312a, such as a cellular network or long-range antenna, and/or a second antenna 312b, such as a Wi-Fi®, Bluetooth®, and/or other short-range antenna), input devices 316a-b (e.g., a first input device 316a, such as a camera and/or a second input device 316b, such as a microphone), and/or output devices 318a-b (e.g., a first output device 318a, such as a display screen (e.g., touch-sensitive interface), and/or a second output device 318b, such as a speaker). According to some embodiments, the mobile electronic device 302 (and/or the display screen 318a thereof) may output a GUI 320 that provides output from and/or accepts input for, a mobile device application executed by the mobile electronic device 302. According to some embodiments, the application may comprise a web-interface application, such as a web browser that provides the GUI 320 based on webpages and/or data served by the server 310.

In some embodiments, the mobile electronic device 302 (and/or the input devices 316a-b thereof) may be utilized to capture, sense, record, and/or be triggered by objects, data, and/or signals proximate to the mobile electronic device 302. The camera 316a of the mobile electronic device 302 may be utilized, for example, to capture an image (e.g., in response to image capture guidance and/or rules) of one or more textual indicia 332 within visual proximity to the mobile electronic device 302. As depicted, for example, the camera 316a may be utilized to capture an image (and/or video) of an insurance identification card 332 (e.g., or other identification card). Optical Character Recognition (OCR) and/or other image analysis rules and/or logic may, in some embodiments, be executed by the mobile electronic device 302 to (i) capture an image of the insurance identification card 332 (or a portion thereof), (ii) identify at least one data field 332-1 on the insurance identification card 332, and (iii) identify a field value 332-2, such as a plurality of alphanumeric characters (and/or other information, such as encoded information) representing the identified at least one data field on the insurance identification card 332. In some embodiments, the mobile electronic device 302 may also or alternatively request that the server 310 provide access to an accident and/or claim reporting functionality (e.g., a webpage) and may capture the image of the insurance identification card 332 in response to the server 310. In some embodiments, the server 310 may direct the user and/or the camera 316a, for example, to acquire the image/video/scan and may conduct the image processing at the server 310.

According to some embodiments, the mobile electronic device 302 and/or server 310 may identify the at least one data field 332-1, such as the “Policy Number” field of the insurance card 332, as depicted in FIG. 3. The mobile electronic device 302 may, for example, analyze an image of the insurance card 332 and apply image processing logic to identify the “Policy Number” characters and/or other indicia that indicates a desired area of information. In some embodiments, an offset rule (e.g., a rule specifying that characters adjacent to, such as below, the identified portion or header are to be captured) and/or other logic may be applied to identify and/or locate the field value 332-2, such as the policy number “010101234567”, as depicted. According to some embodiments, other fields, data, and/or indicia (e.g., human and/or computer-readable) may be utilized. In some embodiments, the field value 332-2 may be transmitted to the server 310 for verification and/or as the basis for an information query. The field value 332-2 may be utilized, for example, to query a database 340 in communication with the server 310 (and/or the mobile electronic device 302). According to some embodiments, the query may return data stored in association with the field value 332-2 (e.g., a particular insurance policy number, account, insured, etc.) and the mobile electronic device 302 may output (e.g., in response to a command from the server 310 including GUI generation instructions) some or all of such data as verification data 344 via the GUI 320 and/or display screen 318a.

In some embodiments, the verification data 344 may comprise: (i) first verification data 344a such as a “policy number”; (ii) second verification data 344b such as a “vehicle” identifier; and/or (iii) third verification data 344c such as a “driver” identifier. According to some embodiments, the GUI 320 may comprise a verification checkbox element 344-1 that permits the user/insured to provide input indicating a verification of the policy number 344a (and/or to edit, correct, and/or enter different data). In some embodiments, the GUI 320 may comprise one or more drop-down menu elements 344-2a, 344-2b that permit the user/insured to provide input indicating a selection of one of a plurality of available data options. In the case of the vehicle 344b and the driver 344c, for example, the user/insured may utilize a first drop-down menu element 344-2a to view a listing of vehicles (and/or other objects; e.g., insured objects) associated with the policy number 344a in the database 340 and/or to select (and/or enter additional) one or more appropriate vehicles (and/or other objects), e.g., involved in an accident. Further, the user/insured may utilize a second drop-down menu element 344-2b to view a listing of drivers (or other individuals) associated with the policy number 344a in the database 340 and/or to select (and/or enter additional) one or more appropriate drivers/individuals, e.g., involved in an accident. In such a manner, for example, in the case that the information captured and identified from the insurance card 332 is accurate, a claim reporting application of the electronic mobile device 302 (and/or a web-based GUI 320 served by the server 310) may be pre-loaded with appropriate policy-related data (e.g., from the database 340) to both speed the entry/selection of the correct information, as well as to minimize potential errors (e.g., due to data entry mistakes, which may be particularly prevalent at an accident scene).

Fewer or more components 302, 302-1, 310, 312a-b, 316a-b, 318a-b, 320, 332, 332-1, 332-2, 340, 344a-c, 344-a, 344-2a, 344-2b and/or various configurations of the depicted components 302, 302-1, 310, 312a-b, 316a-b, 318a-b, 320, 332, 332-1, 332-2, 340, 344a-c, 344-1, 344-2a, 344-2b may be included in the system 300 without deviating from the scope of embodiments described herein. In some embodiments, the components 302, 302-1, 310, 312a-b, 316a-b, 318a-b, 320, 332, 332-1, 332-2, 340, 344a-c, 344-1, 344-2a, 344-2b may be similar in configuration and/or functionality to similarly named and/or numbered components as described herein. In some embodiments, the system 300 (and/or portion thereof) may comprise an automatic accident analysis program, system, and/or platform programmed and/or otherwise configured to execute, conduct, and/or facilitate the method 400 of FIG. 4 herein, and/or portions thereof.

### III. Real-Time Accident Analysis Processes

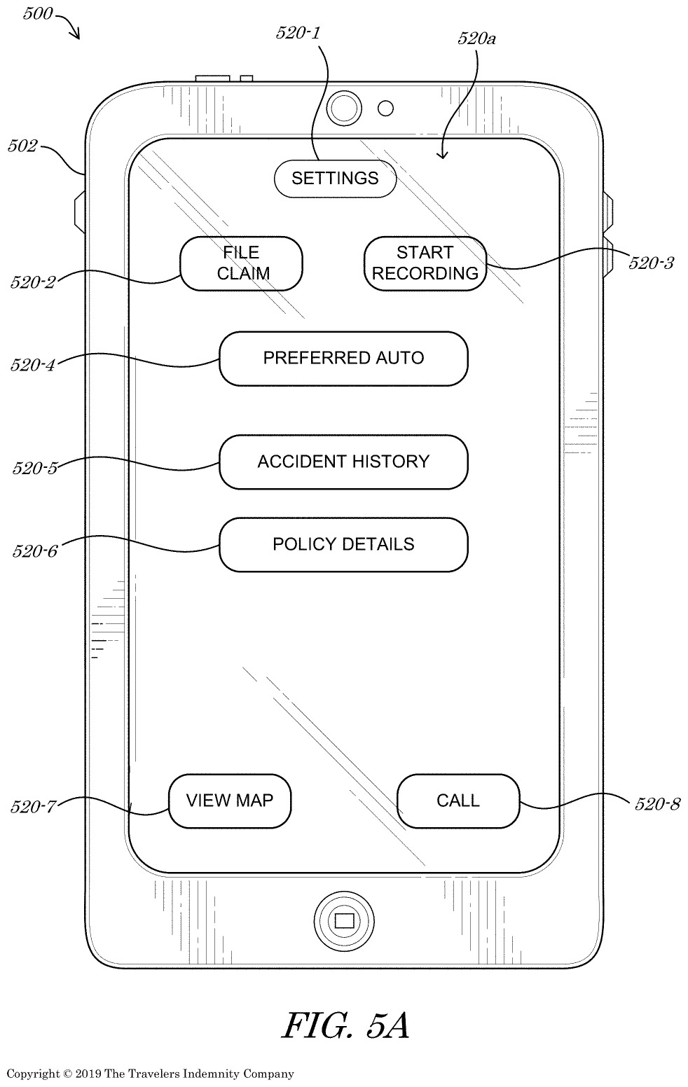

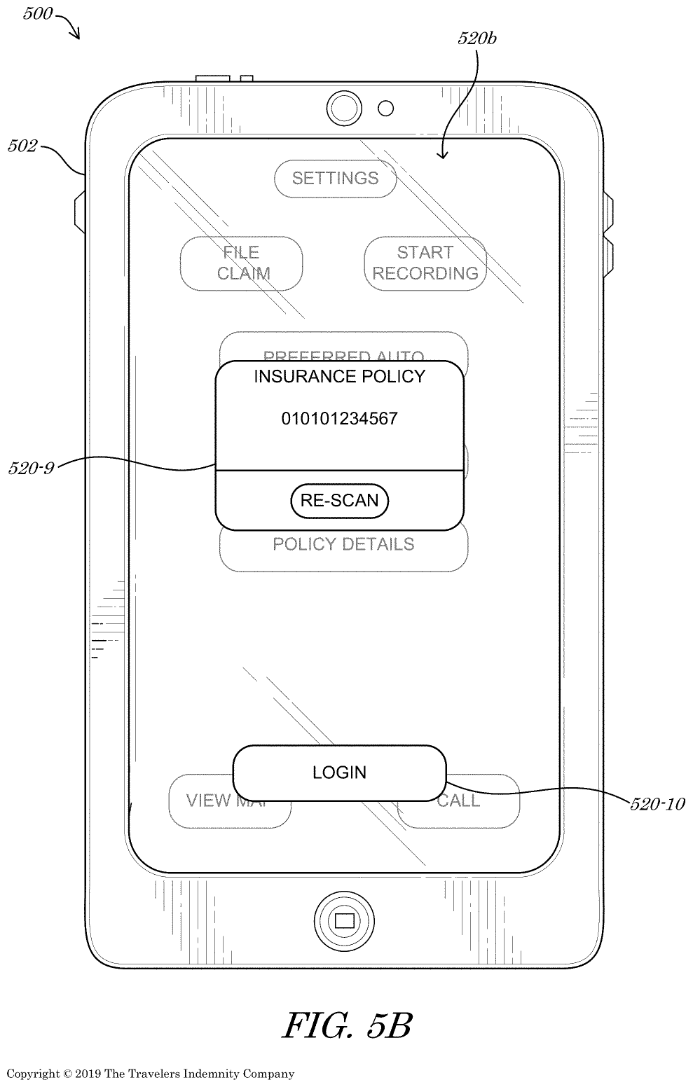

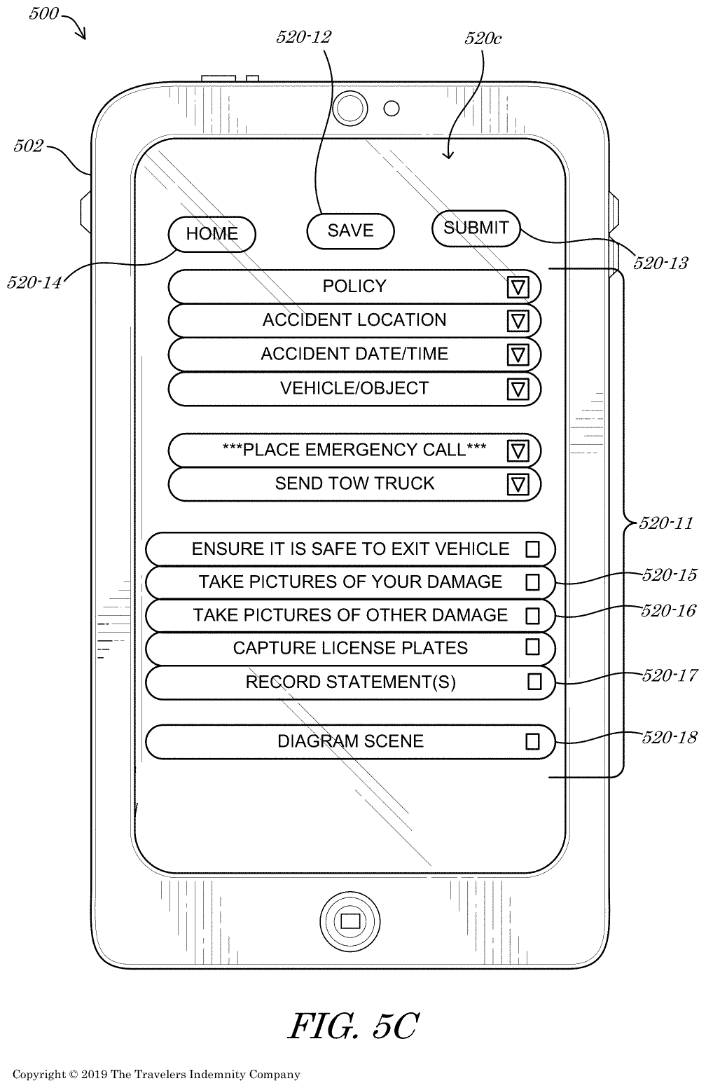

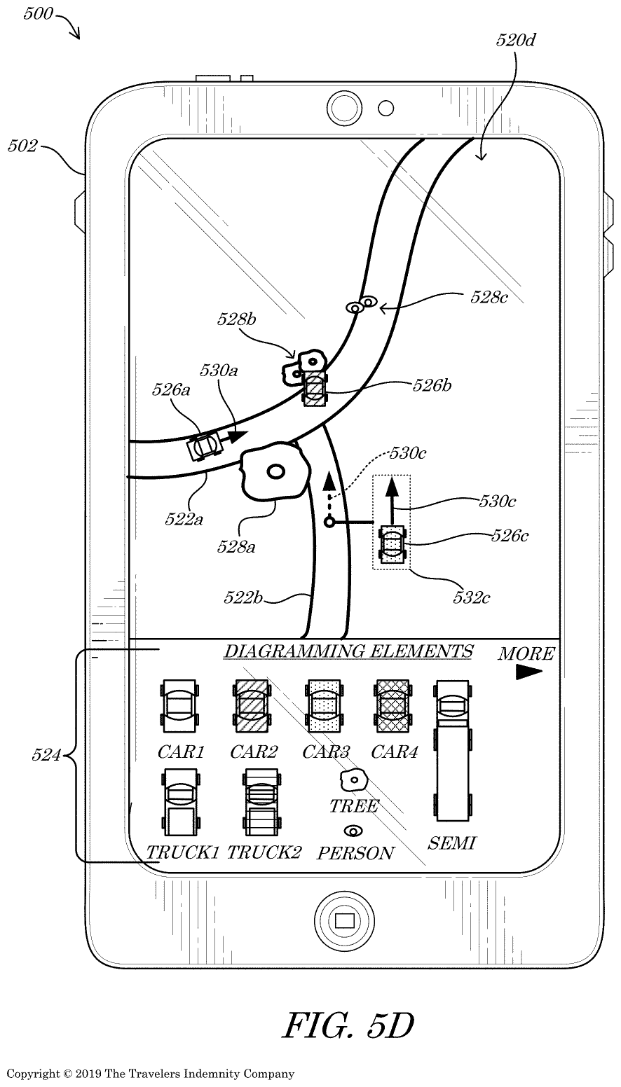

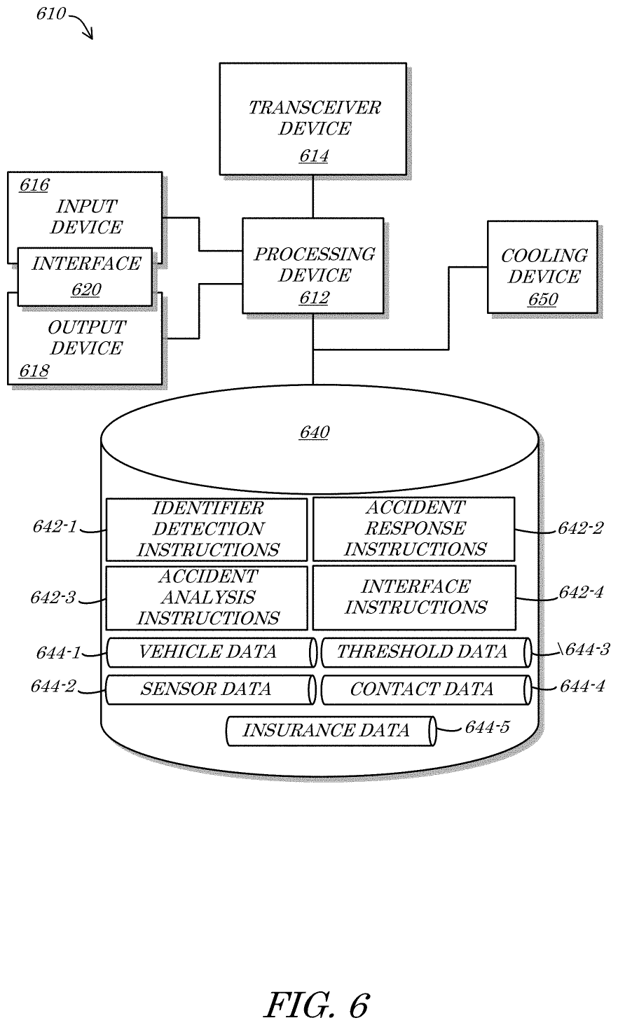

Turning now to FIG. 4, a flow diagram of a method 400 according to some embodiments is shown. In some embodiments, the method 400 may be performed and/or implemented by and/or otherwise associated with one or more specialized and/or specially-programmed computers (e.g., the user/mobile electronic device 102a, 202a, 302 and/or the server 110, 310 of FIG. 1, FIG. 2, and/or FIG. 3 herein), computer terminals, computer servers, computer systems and/or networks, and/or any combinations thereof (e.g., by one or more multi-threaded and/or multi-core processing units of an insurance company claims data processing system). In some embodiments, the method 400 may be embodied in, facilitated by, and/or otherwise associated with various input mechanisms and/or interfaces (such as the interfaces 220, 320, 520a-d, 620 of FIG. 2, FIG. 3, FIG. 5A, FIG. 5B, FIG. 5C, FIG. 5D, and/or FIG. 6 herein).

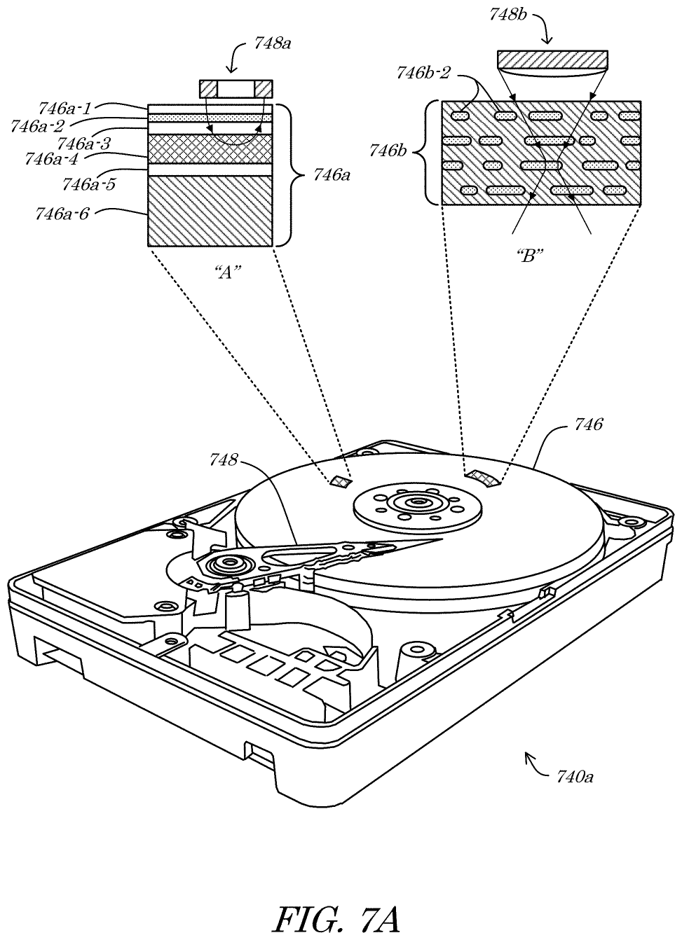

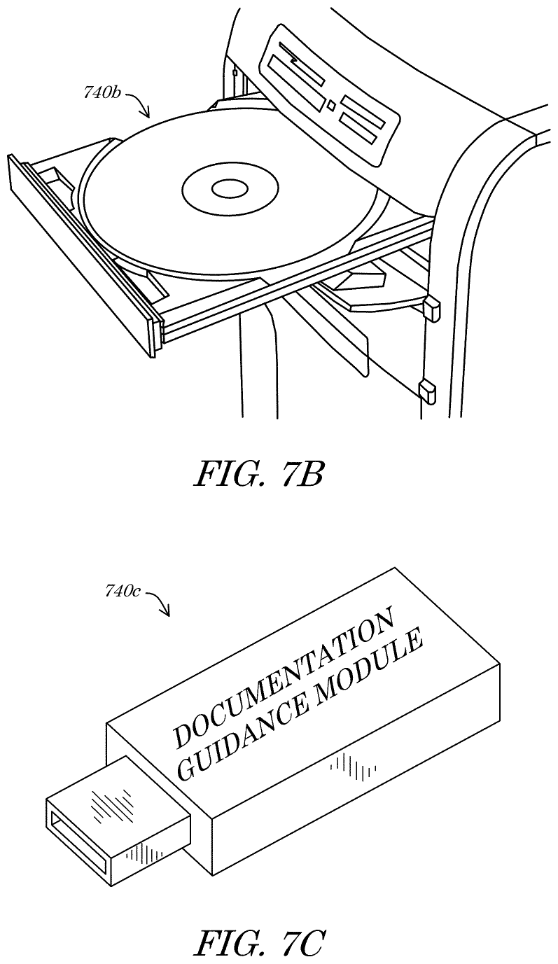

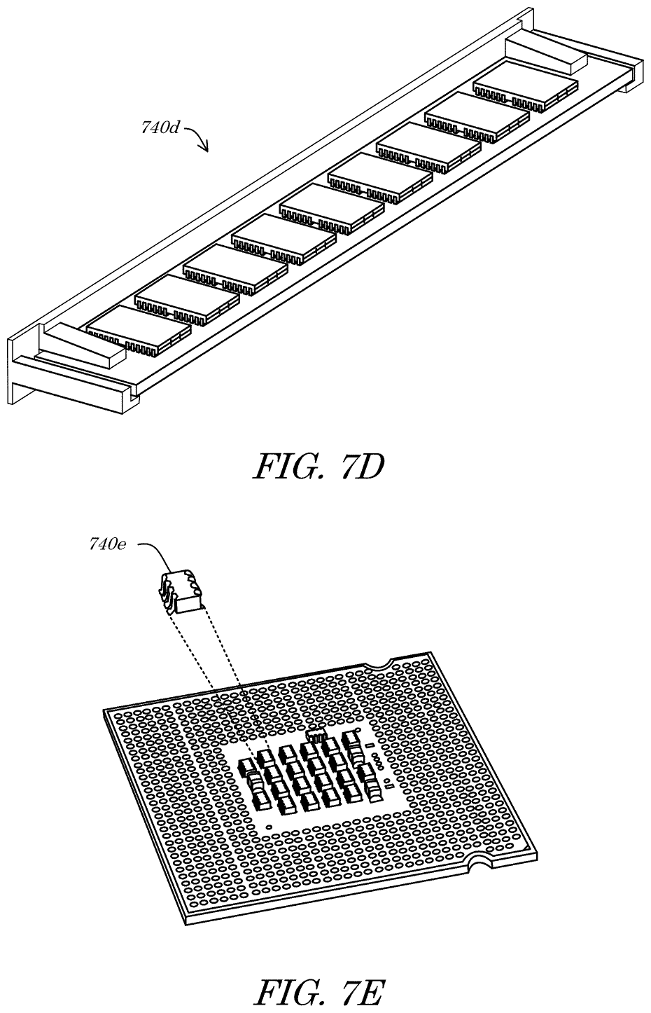

The process diagrams and flow diagrams described herein do not necessarily imply a fixed order to any depicted actions, steps, and/or procedures, and embodiments may generally be performed in any order that is practicable unless otherwise and specifically noted. While the order of actions, steps, and/or procedures described herein is generally not fixed, in some embodiments, actions, steps, and/or procedures may be specifically performed in the order listed, depicted, and/or described and/or may be performed in response to any previously listed, depicted, and/or described action, step, and/or procedure. Any of the processes and methods described herein may be performed and/or facilitated by hardware, software (including microcode), firmware, or any combination thereof. For example, a storage medium (e.g., a hard disk, Random Access Memory (RAM) device, cache memory device, Universal Serial Bus (USB) mass storage device, and/or Digital Video Disk (DVD); e.g., the memory/data storage devices 140, 340, 640, 740a-e of FIG. 1, FIG. 3, FIG. 6, FIG. 7A, FIG. 7B, FIG. 7C, FIG. 7D, and/or FIG. 7E herein) may store thereon instructions that when executed by a machine (such as a computerized processor) result in performance according to any one or more of the embodiments described herein.

According to some embodiments, the method 400 may comprise receiving (e.g., by a webserver and/or via an electronic communications network and/or from a remote user device) a request for an accident analysis webpage (and/or application), at 402. A user of a mobile electronic device and/or of a server may, for example, open, run, call, execute, and/or allow or enable a software program and/or application programmed to analyze accident and/or claim inputs. In some embodiments, the request may comprise a request, from a mobile electronic device to a remote server, to initiate a webpage and/or application. According to some embodiments, the request may be sent and/or triggered automatically, for example, upon detection of an accident or other loss event.

In some embodiments, the method 400 may comprise serving (e.g., by the webserver and/or to the user device) an accident analysis login webpage (and/or other GUI), at 404. According to some embodiments, the login webpage may comprise instructions requesting login credentials and/or data from a user/user device. The login webpage may, for example, be output via the user device and/or GUI thereof and may prompt the user to activate a camera of the user's device and capture an image of an insurance and/or other identification card. In some embodiments, the serving may comprise a transmission of a command to automatically activate the camera and may prompt the user to verify and/or select when image capture should occur (e.g., verify when the camera is pointed at an insurance card).

According to some embodiments, the method 400 may comprise receiving (e.g., by the webserver and/or via the electronic communications network and/or from the user device) an image, at 406. An image of an insurance card (or portion thereof) may be received, for example, in response to the serving of the login webpage. According to some embodiments, the receiving of the image may be in response to instructions/prompts provided via and/or with the login webpage or and/or may be in response to an automated image capture sequence initiated by the webserver via the user device.

In some embodiments, the method 400 may comprise analyzing (e.g., by the webserver) the image, at 408. Stored rules may define, for example, one or more optical and/or other character and/or object recognition routines and/or logic that are utilized to identify (i) one or more areas of the insurance card to search for data and (ii) one or more characters and/or other data resident in the one or more areas of the image. In some embodiments, the image may be analyzed to identify an account number and/or other identifier, such as an insurance policy number.

According to some embodiments, the method 400 may comprise defining (e.g., by the webserver) login credentials, at 410. The insurance policy (and/or other identification data) derived from the image data received from the user device may, for example, be utilized to authorize access to accident and/or claim submission functionality offered by or via the webserver (and/or associated application). In some embodiments, the user and/or user device may be prompted for additional data for credentialing, such as biometric data (e.g., fingerprint data from a fingerprint reader of the user device), a password or phrase (typed, spoken, and/or defined by touch-screen gesture input), and/or two-factor authentication verification.

In some embodiments, the method 400 may comprise retrieving (e.g., by the webserver and/or from a database) policy data, at 412. The credentials and/or the data identified from the captured image/video may, for example, be utilized to query a data store that relates policy identification information to policy detail information. According to some embodiments, the policy data may comprise a listing of vehicles and/or objects/structures for the policy, a listing of drivers/users/operators for the policy, and/or other policy data, such as effective date, expiration date, emergency contact information, etc.

According to some embodiments, the method 400 may comprise serving (e.g., by the webserver and/or to the user device) a data verification webpage (and/or other GUI), at 414. The user device may output/display, in response to the serving for example, a data verification GUI that permits the user to review and accept, reject, or modify the data retrieved at 412. In some embodiments, the data verification webpage/GUI may comprise one or more GUI elements, such as drop-down menu items, that provide selectable listings of vehicles/objects/structures, drivers, policies, options, and/or other data for the policy/account. According to some embodiments, the data verification webpage/GUI may be pre-populated with automatically selected data items that are identified utilizing stored data selection rules.

In some embodiments, the method 400 may comprise receiving (e.g., by the webserver and/or via the electronic communications network and/or from the user device) data verification, at 416. Input received via the GUI input elements of the data verification webpage/GUI may, for example, be received by the webserver. According to some embodiments, the received data may be utilized to (i) verify accuracy of the retrieved policy data, (ii) select a policy data option from a list of options (e.g., one or more vehicles and/or drivers selected from a list of vehicles and drivers on the policy), and/or (iii) define and/or store new and/or edited data (e.g., via direct user data input).

According to some embodiments, the method 400 may comprise capturing (e.g., by an electronic processing device of the webserver and/or the user device) accident inputs, at 418. Accident inputs may comprise, for example, data entered by a driver/user via a provided interface (such as answers to checklist questions and/or queries), pre-accident sensor data from one or more mobile device, vehicle, and/or other sensors, post-accident sensor data from one or more mobile device, vehicle, and/or other sensors, data identified, detected, and/or calculated based on sensor data, third-party data (e.g., weather service data, car manufacturer data, other insurance company data), and/or other pre-stored data (e.g., driver/user/customer insurance policy, identifier, and/or account information). In some embodiments, accident inputs may be automatically identified and/or captured (e.g., based on a set of accident analysis rules by automatically activating a sensor device of a vehicle in wireless communication with the mobile electronic device executing the application). Vehicle bird's-eye camera array video data may be automatically accessed and/or retrieved, for example (e.g., for certain types of accidents and/or when certain types of vehicles or sensors are available), upon occurrence and/or identification of an accident event.

According to some embodiments, capturing of data relevant to the accident event may comprise automatically detecting other electronic devices in proximity of the accident scene (e.g., via signal identification, strength, and/or triangulation measurements), automatically connecting a mobile device to a vehicle and downloading vehicle status and/or recorded vehicle information, storing timestamp data, and/or accessing, identifying, and/or recording other device data, such as device application execution and/or webpage access history data, event logs, and/or a log of the status of the application, GUI, and/or webpage itself. In the case that the webpage/application was initiated (e.g., at 402/404) prior to an accident, for example, it may be identified that the webpage/application was paused or exited before, during, or after the accident. It may be inferred, for example, that if the webpage/application was paused or suspended, a different webpage/application must have been utilized on the user device. Activation and/or usage events for other webpages, communications, and/or applications may be captured and/or stored. According to some embodiments, any or all accident evidence or data may be stored through the webpage/application, e.g., in a directory native to the webpage/application. In such a manner, for example, the user of the user device may only be able to access the evidence (e.g., images/video) through the webpage/application, which may be programmed to limit access and/or prevent editing to establish a chain of evidence for any recorded information. If images taken by a user device were stored in the user device's default photo storage location, for example, they may be accessed, edited, and/or deleted at the will of the user. In the case they are only accessible through the webpage/application, however (e.g., by being stored in a proprietary directory location and/or being encrypted and/or scrambled), the accuracy and/or integrity of the evidence may be verified and/or preserved by the webpage/application.

In some embodiments, capturing of the accident/event inputs may comprise various subroutines and/or processes that guide the user through acquisition of the desired claim/accident data. The method 400 and/or the capturing of the accident inputs at 418 may comprise, for example, serving an input guidance webpage/GUI, at 418A. The input guidance may comprise, in some embodiments, rules-based prompts that direct the user (and/or user device) to conduct certain actions. In the case of accident/event imagery, for example, the guidance may comprise real-time guidance (e.g., defined by stored accident visual documentation rules) directing the user to orient the user device camera in a certain manner to capture one or more desired images. In the case of a recorded statement (e.g., of the user, a witness, a police officer, etc.), the user may be prompted (e.g., in accordance with accident recorded statement rules) to record explanations and/or answers to certain questions. In the case of an accident diagram, the user may be prompted to diagram certain objects and/or features (e.g., vehicles and/or directions of travel, sequence of events, etc.).

According to some embodiments, the method 400 and/or the capturing of the accident inputs at 418 may comprise receiving user input, at 418B. Various data may, for example, be provided by the user to the webserver/application in response to the guidance provided at 418A. In some embodiments, the user input may comprise one or more images and/or videos, one or more audio recordings (e.g., recorded statement(s)), and/or one or more graphical diagramming inputs (e.g., self-diagramming inputs, such as lines, points, vectors, object locations, speeds, etc.). According to some embodiments, data descriptive of the user's capturing/recording of requested data may be received. In the case of imagery input, for example, information descriptive of an orientation, angle, zoom, field of view, and/or other data descriptive of current usage of the user device camera may be received, e.g., from the user device.

In some embodiments, the method 400 and/or the capturing of the accident inputs at 418 may comprise analyzing the user inputs, at 418C. The input data (e.g., images, audio, and/or graphical input) may, for example, be compared to stored rules, thresholds, and/or criteria to determine whether the input complies with input requirements, at 418D. In some embodiments, the input may be processed by being filtered, decoded, converted, and/or by applying one or more algorithms, such as an object detection algorithm for image data or a text-to-speech algorithm for audio data. In some embodiments, the processed data and/or resulting information (e.g., detected objects and/or phrases) may be compared to the stored rules (e.g., accident visual documentation rules, accident recorded statement rules, and/or accident diagram rules), thresholds, and/or criteria to determine whether the input complies with input requirements, at 418D. In the case of a recorded statement audio recording, for example, the audio may be converted to text and the text may be analyzed to determine whether the user has successfully recorded each of two (2) different witnesses to an accident (e.g., utilizing voice identification algorithms). In the case of graphical scene diagram input, the input may be analyzed to determine whether each of three (3) vehicles involved in an incident have been assigned a graphical representation, position, and/or vector.

According to some embodiments, in the case that it is determined at 418D that the input does not comply with one or more requirements, the method 400 may revert to 418A to provide updated and/or additional guidance to the user. In the case that one or more images of one or more vehicles are missing, one or more recorded statements from one or more witnesses are missing, and/or one or more graphical elements to form a complete accident diagram are missing, for example, such missing elements/input may be identified to the user (e.g., along with detailed instructions regarding how such missing input should be obtained).

In some embodiments, the progression from 418A to 418B to 418C to 418D may be conducted in real-time. Real-time analysis of camera input and/or captured images, for example, may permit a user's actions to be re-directed during and/or immediately after data capture. Such real-time analysis may, according to some embodiments, be utilized to verify that imagery captured by the user/user device satisfies the pre-stored criteria for accident/event documentation. The user may be initially prompted to capture imagery of various views of their own vehicle (e.g., at 418A), for example, and upon real-time review of the captured images (e.g., at 418C) it may be determined that an image of the front of the vehicle is missing or not captured with sufficient clarity (e.g., for an object detection routine to determine if there is damage pictured in the image), and the user may accordingly be instructed to capture the missing image.

According to some embodiments, audio input may be interrupted to prompt the user to answer a specific question or even to answer a question posed by the user to the system. In some embodiments, recorded statement prompts and/or questions may direct the user to provide any or all of the following data items (either personally or by interviewing a witness): (i) informed consent to the recording; (ii) driver identification information (name, license number, date of birth, address); (iii) whether the driver owns the vehicle or had permission to use the vehicle; (iv) where the vehicle is garaged; (v) if the driver has possession of a set of keys for the vehicle; (vi) whether the driver regularly uses the vehicle; (vii) whether the driver/user was injured; (viii) identifying information of others that were injured; (ix) injury details (parts of body, extent); (x) how injury occurred (injury mechanics as related to the vehicle); (xi) details on initial treatment; (xii) details of any diagnostic injury testing done; (xiii) resulting medication information; (xiv) scheduled follow-up treatment details; (xv) details of prior accidents and/or injuries; (xvi) details regarding other medical conditions; (xvii) health insurance information; (xviii) description of the vehicle(s); (xix) details of any passengers; (xx) purpose of trip; (xxi) if trip was during working hours and/or if driver was being paid; (xxii) employer information; (xxiii) weather description; (xxiv) roadway description (number of lanes, straight or on a curve, intersection, traffic controls); (xxv) description of damage; (xxvi) details of any driving obstructions; (xxvii) vision information (contacts, glasses); (xxviii) details on perceived fault; (xxix) details on perceived speeds; and/or (xxx) police details (who responded, who received a citation).

In some embodiments, dynamic diagramming feedback may prompt the user to identify each vehicle (or other object) involved, prompt the user to assign vector input to a graphical representation of a diagrammed vehicle, and/or provide graphical element relocation guidance (e.g., not permit a user to diagram a vehicle off of a travel way (or apply other graphical and/or spatial diagramming constraints). In the case that a user draws/places a graphical representation of a vehicle in a lake, field, and/or conflicting with a building location, for example, the user may be prompted to confirm that the conflicting (or unusual) location is indeed the desired location.

In some embodiments, in the case that the input is determined to comply with stored constraints/criteria at 418D, the method 400 may proceed to determine whether additional input is required, at 418E. In the case that additional input is needed, the method 400 may proceed back to provide input guidance at 418A. The method 400 may, for example, loop through capturing of accident inputs at 418 by first guiding a user through acquiring adequate documentary imagery of an accident/event, then acquiring an adequate quantity and content for recorded statements, then through a self-diagramming accident/scene sketching process. In some embodiments, once each of these (or fewer or more desired input actions) is accomplished, the method 400 may proceed. In some embodiments, any or all user input may be automatically uploaded and/or mapped to various respective form fields into one or more third-party websites and/or forms (such as a police FR-10 Form) to automatically order copies of official reports (e.g., police reports) and/or other incident/accident-related data.

According to some embodiments for example, the method 400 may comprise analyzing (e.g., by the electronic processing device) the accident inputs (e.g., image data, audio data, and/or GUI diagramming data), at 420. Accident inputs may be processed utilizing stored rules (e.g., accident analysis rules) and/or analysis modules (such as mathematical models, physics modeling, etc.), for example, to identify and/or estimate relevancy of captured data and/or relationships between captured data elements. According to some embodiments, image, video, audio, and/or diagramming evidence may be analyzed to calculate estimated distances between objects at the accident scene and/or orientations and/or positions of objects at or near the scene. Image analysis may include object, facial, pattern, and/or spatial recognition analysis routines that, e.g., identify individuals at the scene, identify vehicles at the scene, identify roadway features, obstacles, weather conditions, etc. Signal analysis may be utilized, in some embodiments, to identify other electronic devices at or near the scene (e.g., other smart phones, cell towers, traffic monitoring devices, traffic cameras, traffic radar devices, etc.). According to some embodiments, image and/or sensor analysis may be utilized to estimate accident damage by itemizing vehicle parts (or non-vehicle parts, such as structures or other obstacles) that visually appear to be damaged. In some embodiments, object (e.g., vehicle) movement, paths, and/or directions, or speeds may be estimated by analyzing locations at different points in time.

In some embodiments, the method 400 may comprise computing or calculating (e.g., by the electronic processing device) an accident result, at 422. Based on the analysis at 420 and/or the accident inputs (such as a user-created scene diagram), for example, one or more rules and/or logic routines may be applied to determine (i) which party (or parties) is responsible for the accident/incident (e.g., causation), (ii) contributing factors to the accident (e.g., weather, brake failure, excessive speed, poor visibility, poor road design/layout, obstacle locations, etc.), (iii) how much damage has been done to various vehicles and/or objects due to the accident (e.g., a monetary and/or other quantitative metric), and/or (iv) how much should be paid for an insurance claim based upon the accident event (e.g., based upon insurance policy parameters, causation results, logical claim analysis rules, etc.). According to some embodiments, one or more lookup tables and/or other data sources may be queried to identify values associated with different levels of causation, vehicle parts and/or labor amounts, and/or claims payment rules.

According to some embodiments, the method 400 may comprise transmitting (e.g., by the electronic processing device and/or a wireless transceiver device, and/or via the electronic communications network) the accident result, at 424. In the case that the accident result comprises a determination and/or quantification of accident causation or fault, for example, the result may be transmitted to the appropriate authorities and/or to an insurance company claim system and/or representative. In the case that the result comprises a listing of damaged parts and/or a monetary estimate of damage, the accident result may be transmitted to a repair center, appraisal specialist, parts dealer, manufacturer, etc. In some embodiments, a likelihood of fault of an insurance customer may be multiplied by the estimated damage (e.g., to a vehicle of the insurance customer) amount to calculate an amount that the insurance claims handling process should provide in response to a claim. According to some embodiments, the detection of the accident and/or transmitting may comprise an initiation of a claims handling process (e.g., by automatically dialing an insurance company claims telephone hotline and/or by automatically uploading accident information to an automated claims handling platform managed by a remote insurance company server device).

### IV. Automated Accident Analysis Interfaces

Turning now to FIG. 5A, FIG. 5B, FIG. 5C, and FIG. 5D, diagrams of a system 500 depicting a user device 502 providing instances of an example interface 520a-d according to some embodiments are shown. In some embodiments, the interface 520a-d may comprise a web page, web form, database entry form, API, spreadsheet, table, and/or application or other GUI by which a user or other entity may enter data (e.g., provide or define input) to enable receipt and/or management of real-time accident detection, verification, and/or analysis information and/or trigger automatic accident detection, verification, and/or analysis functionality, as described herein. The interface 520a-d may, for example, comprise a front-end of a real-time accident detection, verification, and/or analysis program and/or platform programmed and/or otherwise configured to execute, conduct, and/or facilitate the systemic method 400 of FIG. 4 herein, and/or portions thereof. In some embodiments, the interface 520a-d may be output via a computerized device, such as the user device 502, which may, for example, be similar in configuration to one or more of the user/mobile electronic devices 102a, 202a, 302 and/or the server 110, 310 or the apparatus 610, of FIG. 1, FIG. 2, FIG. 3, and/or FIG. 6 herein.

According to some embodiments, the interface 520a-d may comprise one or more tabs and/or other segmented and/or logically-presented data forms and/or fields. In some embodiments, the interface 520a-d may be configured and/or organized to allow and/or facilitate entry and/or acquisition of information regarding an accident event, scene, and/or device or object associated with such an event and/or scene. According to some embodiments, the interface 502a-d may comprise a menu page from which a user may select one or more options that initiate specific functionality of a mobile device application executed by the user device 502 (e.g., a natively-installed application or program and/or a program facilitated by a native application—e.g., a web-based application executed in a local browser). As depicted in FIG. 5A, for example, a first version (or page or instance) of the interface 520a may comprise a “Menu” or “Home Page” interface (e.g., defining a first input and/or output mechanism) by providing an area (e.g., one or more data entry mechanisms, tools, objects, and/or features) that provides for selection/activation of (i) a “settings” button 520-1, (ii) a “file claim” button 520-2, (iii) a “start recording” button 520-3, (iv) a “preferred auto” button 520-4, (v) an “accident history” button 520-5, (vi) a “policy details” button 520-6, (vii) a “view map” button 520-7, and/or (viii) a “call” button 520-8.

In some embodiments, the first version (or page or instance) of the interface 520a may be utilized to enable access to various accident detection/analysis information and/or functionality. The settings button 520-1 may, when actuated or selected by the user, for example, permit definition and/or editing of values that govern various settings and/or preferences, such as camera and/or sensor recording frequencies, resolutions, and/or loop settings, insurance policy information, vehicle information, contact information, and/or rules definitions. Rules definitions may comprise, for example, definitions for one or more rules that govern (i) accident detection (e.g., sensor threshold settings), (ii) accident verification (e.g., comparative sensor algorithms), and/or (iii) accident responses (e.g., types of accident and appropriate responses).

According to some embodiments, the file claim button 520-2 may, when actuated or selected by the user, initiate a sub-routine that transmits a signal to an insurance company server (not shown) and provides accident notification, details, and/or evidence (e.g., camera images/video, audio, scene diagram data). In some embodiments, the file claim button 520-2 may be generated and/or enabled upon automatic detection (e.g., based on upon sensor threshold settings) of an accident event and/or may be output as a prompt to request claim initiation by a user (not shown). According to some embodiments, the start recording button 520-3, when actuated or selected by the user, initiates a sub-routine that activates a recording of image, audio, video, and/or other electronic data feed from a sensor, such as a camera and/or camera array as described herein. In some embodiments, the sensor feed may be recorded from a sensor coupled to the user device 502 (not separately depicted) and/or from a sensor of a different device (not shown), such as a vehicle or other sensor within communication range of the user device 502. According to some embodiments, the start recording button 520-3 may activate an automatic sensor data capture routine, such as an auto-record feature that triggers recording automatically upon detection of an accident event.

In some embodiments, the preferred auto button 520-4 may, when actuated or selected by the user, for example, initiate a sub-routine that directs the user to information input and/or output areas (e.g., additional interface views) for preferred auto information. According to some embodiments, the accident history button 520-5 may, when actuated or selected by the user, for example, initiate a sub-routine that provides information detailing previous accident event, scene, reconstruction, claim submission results, and/or other accident-related data for the user (e.g., stored in association with an account of the user). In some embodiments, the policy details button 520-6 may, when actuated or selected by the user, for example, initiate a sub-routine that directs the user to information input and/or output areas (e.g., additional interface views) for insurance policy (e.g., personal, fleet, auto collision and/or liability insurance policy) information. According to some embodiments, the view map button 520-7 may, when actuated or selected by the user, for example, initiate a sub-routine that directs the user to a map view or interface screen (not shown) that provides location-based graphical depictions of any or all of (i) the user's current location (e.g., a location of the user device 502 and/or a vehicle of the user—not shown) and/or previous locations (e.g., course taken/travel path), (ii) an accident scene location, (iii) other users' and/or vehicle locations, and/or (iv) accident reconstruction information (e.g., distances between vehicles and/or objects, such as lanes, curbs, obstacles, and/or weather data). In some embodiments, the call button 520-8 may, when actuated or selected by the user, for example, initiate a sub-routine that triggers a communication (e.g., a cellular telephone call, an e-mail, text message, etc.) to one or more stored communication addresses (e.g., an insurance company representative telephone number, a family member's communication address, an emergency telephone number, a repair facility text address, etc.).

In some embodiments, the application may cause the first interface 520a to display other or additional user-selectable menu choices (not shown) including sensor selection and/or pairing options, device discovery options (e.g., signal searching, detection, and/or triangulation), and/or vehicle device controls. The user-selectable menu choices displayed by the application may be part of a library of user-selectable objects. In some embodiments, the library of user-selectable objects includes other user-selectable objects that are selectively included for display based on their determined relevance (e.g., based on pre-stored data associations) to the user, the user device 502, a vehicle, a sensor, an insurance policy, and/or an accident event and/or scene. According to some embodiments, the first version of the interface 520a may not provide functionality to the user unless or until user credentials have been acquired, input, and verified. Any attempt to utilize the first version of the interface 520a may, for example, cause a credentialing process to occur.

Referring to FIG. 5B for example, a second version (or page or instance) of the interface 520b may comprise a credentialing or login interface (e.g., defining a second input and/or output mechanism) by providing an automatic credential detection data prompt 520-9 and/or a login button 520-10. The second version (or page or instance) of the interface 520b may be utilized or served, for example, in response to an analysis of an insurance card (or other identification document) where stored image analysis rules are utilized to identify the policy number thereon. One or more sensors of the user device 502, such as a camera (not shown), may for example, provide image data that is analyzed by a server device (not shown) and/or the application executed by the user device 502, with such analysis triggering the automatic credential detection data prompt 520-9. In some embodiments, the automatic credential detection data prompt 520-9 may display the policy number obtained from the insurance card and a “re-scan” button that allows the user to re-analyze the image data and/or correct or edit the policy number. According to some embodiments, the automatic credential detection data prompt 520-9 of the second version of the interface 520b may, for example, upon a triggering and/or receipt of input from the user (e.g., a properly-positioned click of a mouse or other pointer) with respect to the automatic credential detection data prompt 520-9 (and/or the “re-scan” button thereof), initiate a sub-routine that causes a querying of additional sensor or image data and/or a re-querying of originally-acquired sensor or image data.

According to some embodiments, the login button 520-10 of the second version of the interface 520b may, for example, upon a triggering and/or receipt of input from the user (e.g., a properly-positioned click of a mouse or other pointer) with respect to the login button 520-10, initiate a sub-routine that may trigger a call to and/or otherwise cause a provision, generation, and/or outputting of a third version of the interface 520c (and/or the third version of the interface 520c may be automatically provided upon policy number identification). In some embodiments, the third version (or page or instance) of the interface 520c may comprise an incident or accident checklist 520-11 providing a plurality of sub-menus, drop-down lists, and/or other input/output features that assist a user in managing an appropriate response to the incident/accident. In some embodiments, the sub-menus, prompts, directions, and/or information provided in the accident checklist 520-11 may be populated with different data depending upon values for certain variables, such as the type of incident/accident, the location of the incident/accident, a number of detected vehicles involved, insurance policy coverages, limits, riders, and/or restrictions, user account information, etc. The “Send Tow Truck?” option may, for example, be linked to specific contact information for repair and/or tow facilities that are proximate to a detected location of an accident (e.g., a location of the user device 502 at the time of detection). In some embodiments, various menus, lists, and/or data values of the accident checklist 520-11 may be pre-populated based on stored data retrieved by utilizing the policy number in a query to a database. The “Vehicle/Object” option may, for example, comprise a drop-down menu that is prepopulated with one or more vehicle identifiers pre-associated with the identified insurance policy.

According to some embodiments, the third version of the interface 520c may comprise a save button 520-12, a submit button 520-13, and/or a home button 520-14. The save button 520-12 may, when actuated or selected by the user, for example, initiate a sub-routine that stores any or all accident and/or incident data entered by the user (e.g., in response to and/or utilizing the accident checklist 520-11 input features and/or prompts) and/or automatically captured (e.g., from one or more sensors). In such a manner, for example, a user may begin an accident report and/or claims process and save entered information for later completion of the accident checklist 520-11 and/or claim submission. In some embodiments, the submit button 520-13 may, when actuated or selected by the user, for example, initiate a sub-routine that transmits any or all saved, input, and/or captured data (e.g., text details of a user's description of the accident, captured video/images of the accident scene, optically-recognized character information from image data, recorded statement data, scene diagram data, etc.) to a remote server (not shown; e.g., the server 110, 310 of FIG. 1 and/or FIG. 3 herein). The submit button 520-13 may, for example, trigger an initiation of a claims process with an insurance carrier by uploading data values and/or fields into one or more insurance carrier databases, forms, and/or data storage columns and/or features. According to some embodiments, the home button 520-14 may, when actuated or selected by the user, for example, trigger a call to and/or otherwise cause a provision, generation, and/or outputting of the first version of the interface 520a (e.g., the “home” screen).

In some embodiments, one or more options of the accident checklist 520-11 may generate additional interface versions, screens, and/or GUI elements (not shown) defined by stored data input guidance rules. The “Take pictures of your damage” option 520-15 and/or the “Take pictures of other damage” option 520-16 may, upon a triggering and/or receipt of input from the user (e.g., a properly-positioned click of a mouse or other pointer) with respect to the “Take pictures of your damage” option 520-15 and/or the “Take pictures of other damage” option 520-16, respectively, initiate a sub-routine that may trigger a call to and/or otherwise cause a provision, generation, and/or outputting of image capture guidance rules (not shown). Such rules may, in some embodiments, actively guide a user through capturing each required item of image data, such as a first photo of a left side of the user's vehicle, a second photo of a right side of the user's vehicle, a third photo of a front end of the user's vehicle, and so on. According to some embodiments, the “Record Statement(s)” option 520-17 may, upon a triggering and/or receipt of input from the user (e.g., a properly-positioned click of a mouse or other pointer) with respect to the “Record Statement(s)” option 520-17, initiate a sub-routine that may trigger a call to and/or otherwise cause a provision, generation, and/or outputting of guidance that steps the user through recording audio statements of one or more accident witnesses by prompting the user to ask the witness certain questions.

According to some embodiments, the “Diagram Scene” option 520-18 of the third version of the interface 520c may, upon a triggering and/or receipt of input from the user (e.g., a properly-positioned click of a mouse or other pointer) with respect to the “Diagram Scene” option 520-18, initiate a sub-routine that may trigger a call to and/or otherwise cause a provision, generation, and/or outputting of a fourth version of the interface 520d. In some embodiments, the fourth version (or page or instance) of the interface 520d may comprise an accident diagram webpage and/or GUI that permits, instructs, and/or guides a user/insured through constructing a diagram of an incident and/or accident scene. The fourth version of the interface 520d may comprise and/or represent, for example, a map-based diagram tool and/or a GUI vector drawing tool. According to some embodiments, the fourth version of the interface 520d may be generated by GUI diagram program code that pre-loads a geo-referenced map image, e.g., as depicted in FIG. 5D. In some embodiments, the map image may comprise the map-based diagram that permits the user to provide input defining one or more points, areas, and/or objects on the generated map image/layer. The user may provide drawing input that defines or verifies, for example, one or more roadways 522a-b (or other travel ways or map boundaries or regions related to the incident/accident). In some embodiments, the user's input may be compared to any pre-loaded map objects/areas to verify and/or adjust locations, sizes, etc. According to some embodiments, the user may be provided with diagramming tools to facilitate scene depiction, particularly for non-static (e.g., changing position over time) elements/objects of the scene.

In some embodiments, the GUI vector drawing tool may be utilized by the user to provide (e.g., via the user device 502 and/or the fourth version of the interface 520d) first vector input that defines a first location on the map and/or a first direction (and/or speed; e.g., a vector). According to some embodiments, the first vector input may be provided in conjunction with and/or utilizing a common GUI object selection tool or library. As depicted in FIG. 5D, for example, the fourth version of the interface 520d may comprise a common GUI object selection area 524 that stores and displays a plurality of common GUI objects, such as those representing various vehicles and objects that may be desired for placement on the map image. In some embodiments, the common GUI object selection area 524 may be utilized by the user clicking on (or otherwise selecting) “CAR1” and dragging a first instance of the “CAR1” object 526a (e.g., a first object) to the location (e.g., on a first roadway 522a) shown on the map image (e.g., providing first GUI object selection input). Similarly, the user may provide input defining selections of other objects and assigning locations for such objects on the map image. As depicted, for example, the user may select and place a “CAR2” object 526b (e.g., a second object) at a location along the first roadway 522a, select and place a “CAR3” object 526c (e.g., a third object) at a location near a second roadway 522b, and/or select and place a plurality of other objects 528a-c, such as a first tree object 528a (e.g., at an intersection of the roadways 522a-b), a second set of tree objects 528b, and/or one or more “PERSON” or pedestrian objects 528c (e.g., along a shoulder of the first roadway 522a).

According to some embodiments, the vector input provided by the user may be represented by vector objects 530a, 530c on the map image/interface. As depicted in FIG. 5D, for example, the first object 526a (“CAR1”) may be graphically positioned with and/or assigned a first vector object 530a that may, in some embodiments, indicate a speed and/or direction of the first object 526a. According to some embodiments, such as in the case of the second object 526b, no vector object (and/or underlying vector data) may be provided—e.g., the “CAR2” may be stopped. In some embodiments, vector objects 530a, 530c may be automatically generated and/or placed with a vehicle object 526a-c. In some embodiments, the vector input may be provided separately from the common object placement. In such embodiments, the accident diagram webpage may execute a routine configured to match vector and/or object input instances provided by the user (e.g., to assist the user in diagramming the scene accurately).

In some embodiments, for example, the user may define a third vector object 530c on the second roadway 522b (the instance of the third vector object 530c shown in dotted line in FIG. 5D) and may place the third object 526c (“CAR3”) near the second roadway 522b and/or the third vector object 530c. According to some embodiments, the accident diagram webpage/tool may calculate a distance between the locations of the third vector object 530c and the third object 526c and may compare the distance to a stored threshold (e.g., an accident diagram rule) to determine whether an assumption should be made that the user intended the third vector object 530c and the third object 526c to be related/associated. In the case that the distance is less than the threshold, for example, it may be automatically determined that the third vector object 530c and the third object 526c should be associated (e.g., a stored spatial data relationship may be generated). In such a case, one or more of the third vector object 530c and the third object 526c may be automatically repositioned to align with the corresponding third vector object 530c or third object 526c. In the case that the distance is greater than the threshold, no relationship may be automatically generated and/or no automatic repositioning may occur. In such a manner, for example, user input processes may be facilitated, particularly for diagramming accomplished “in the field” at an incident/accident site and/or via a mobile device (e.g., an otherwise less-than-desirable diagramming platform).

According to some embodiments, one or more objects 526a-c, 528a-c may be automatically repositioned and/or may trigger alerts, based on locations selected for the objects 526a-c, 528a-c on the map image/interface. In the case that the user places the third object 526c and/or the third vector object 530c (the instance of the third vector object 530c shown in solid line in FIG. 5D) off of the second roadway 522b at a location identified by the dotted box 532c, for example, an accident diagram rule may be applied that identifies a potential error due to the represented “CAR3” vehicle being off of a normal travel way. In such a case, the user may be notified via a warning, message, and/or prompt and asked to verify the desired location. According to some embodiments, the third object 526c and/or the third vector object 530c may be automatically relocated to the nearest area on the map that corresponds to vehicle travel (e.g., the second roadway 522b). In some embodiments, these and/or other areas of the map that correspond to certain characteristics, such as vehicle travel, may be programmed into the accident diagram rules such that a user is guided in placing the objects 526a-c, 528a-c in appropriate areas. According to some embodiments, the rules may be locked such that a user may be prohibited from placing an object 526a-c, 528a-c in a manner that conflicts with a characteristic of the object 526a-c, 528a-c, selected location on the map, and/or a respective vector object 530a, 530c.

In some embodiments, the user-drawn diagram of the scene may be utilized to construct a virtual accident scene model by storing data values representative of any placed objects 526a-c, 528a-c and/or vector objects 530a, 530c. According to some embodiments, the virtual accident scene model may be utilized to calculate an incident/accident result, such as an estimated magnitude and/or type of damage, an estimated cost of repairing the damage, a likelihood of fault for any given vehicle or operator, and/or a computed amount of insurance coverage.

While various components of the interface 520a-d have been depicted with respect to certain labels, layouts, headings, titles, and/or configurations, these features have been presented for reference and example only. Other labels, layouts, headings, titles, and/or configurations may be implemented without deviating from the scope of embodiments herein. Similarly, while a certain number of tabs, information screens, form fields, and/or data entry options have been presented, variations thereof may be practiced in accordance with some embodiments.

### V. Real-Time Accident Analysis Apparatus and Articles of Manufacture

Turning to FIG. 6, a block diagram of an apparatus 610 according to some embodiments is shown. In some embodiments, the apparatus 610 may be similar in configuration and/or functionality to any of the server 110, 310 the third-party device 106, and/or the user/mobile electronic devices 102a, 202a, 302, 502 of FIG. 1, FIG. 2, FIG. 3, and/or FIG. 5 herein. The apparatus 610 may, for example, execute, process, facilitate, and/or otherwise be associated with the method 400 of FIG. 4 herein, and/or portions thereof. In some embodiments, the apparatus 610 may comprise a processing device 612, a transceiver device 614, an input device 616, an output device 618, an interface 620, a memory device 640 (storing various programs and/or instructions 642 and data 644), and/or a cooling device 650. According to some embodiments, any or all of the components 612, 614, 616, 618, 620, 640, 642, 644, 650 of the apparatus 610 may be similar in configuration and/or functionality to any similarly named and/or numbered components described herein. Fewer or more components 612, 614, 616, 618, 620, 640, 642, 644, 650 and/or various configurations of the components 612, 614, 616, 618, 620, 640, 642, 644, 650 be included in the apparatus 610 without deviating from the scope of embodiments described herein.

According to some embodiments, the processor 612 may be or include any type, quantity, and/or configuration of processor that is or becomes known. The processor 612 may comprise, for example, an Intel® IXP 2800 network processor or an Intel® XEON™ Processor coupled with an Intel® E7501 chipset. In some embodiments, the processor 612 may comprise multiple inter-connected processors, microprocessors, and/or micro-engines. According to some embodiments, the processor 612 (and/or the apparatus 610 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 610 comprises a server such as a blade server, necessary power may be supplied via a standard AC outlet, power strip, surge protector, and/or Uninterruptible Power Supply (UPS) device.

In some embodiments, the transceiver device 614 may comprise any type or configuration of communication device that is or becomes known or practicable. The transceiver device 614 may, for example, comprise a Network Interface Card (NIC), a telephonic device, a cellular network device, a router, a hub, a modem, and/or a communications port or cable. In some embodiments, the transceiver device 614 may be coupled to receive sensor data from one or more sensors (not separately depicted), such as in the case that the apparatus 610 is utilized to capture accident scene video/images and/or other data. The transceiver device 614 may, for example, comprise a BLE and/or RF receiver device that acquires broadcast and/or transmitted sensor data and/or a transmitter device that provides such data to a remote server (not shown). According to some embodiments, the transceiver device 614 may also or alternatively be coupled to the processor 612. In some embodiments, the transceiver device 614 may comprise an IR, RF, Bluetooth™, Near-Field Communication (NFC), and/or Wi-Fi® network device coupled to facilitate communications between the processor 612 and another device (such as a vehicle and/or remote server, not shown in FIG. 6).

In some embodiments, the input device 616 and/or the output device 618 are communicatively coupled to the processor 612 (e.g., via wired and/or wireless connections and/or pathways) and they may generally comprise any types or configurations of input and output components and/or devices that are or become known, respectively. The input device 616 may comprise, for example, a keyboard that allows an operator of the apparatus 610 to interface with the apparatus 610 (e.g., by an insurance customer and/or accident victim or witness). In some embodiments, the input device 616 may comprise a sensor, such as a receiver, a camera, a proximity sensor, a vehicle device status sensor, a signal strength meter, etc. The output device 618 may, according to some embodiments, comprise a display screen and/or other practicable output component and/or device. The output device 618 may, for example, provide the interface 620 (such as the interfaces 220, 320, 520a-d of FIG. 2, FIG. 3, FIG. 5A, FIG. 5B, FIG. 5C, and/or FIG. 5D herein) via which automatic accident detection, verification, and/or analysis functionality are provided to a user (e.g., via a website and/or mobile application). According to some embodiments, the input device 616 and/or the output device 618 may comprise and/or be embodied in a single device such as a touch-screen monitor.

The memory device 640 may comprise any appropriate information storage device that is or becomes known or available, including, but not limited to, units and/or combinations of magnetic storage devices (e.g., a hard disk drive), optical storage devices, and/or semiconductor memory devices such as RAM devices, Read Only Memory (ROM) devices, Single Data Rate Random Access Memory (SDR-RAM), Double Data Rate Random Access Memory (DDR-RAM), and/or Programmable Read Only Memory (PROM). The memory device 640 may, according to some embodiments, store one or more of identifier detection instructions 642-1 (e.g., optical character recognition rules and/or text-to-speech conversion rules), accident response instructions 642-2 (e.g., accident visual documentation rules, accident recorded statement rules, and/or accident diagram rules), accident analysis instructions 642-3, interface instructions 642-4, vehicle data 644-1, sensor data 644-2, threshold data 644-3, contact data 644-4, and/or insurance data 644-5. In some embodiments, the identifier detection instructions 642-1, accident response instructions 642-2, accident analysis instructions 642-3, and interface instructions 642-4 may be utilized by the processor 612 to provide output information via the output device 618 and/or the transceiver device 614.

According to some embodiments, the identifier detection instructions 642-1 may be operable to cause the processor 612 to process the vehicle data 644-1, sensor data 644-2, threshold data 644-3, contact data 644-4, and/or insurance data 644-5 in accordance with embodiments as described herein. Vehicle data 644-1, sensor data 644-2, threshold data 644-3, contact data 644-4, and/or insurance data 644-5 received via the input device 616 and/or the transceiver device 614 may, for example, be analyzed, sorted, filtered, decoded, decompressed, ranked, scored, plotted, and/or otherwise processed by the processor 612 in accordance with the identifier detection instructions 642-1. In some embodiments, vehicle data 644-1, sensor data 644-2, threshold data 644-3, contact data 644-4, and/or insurance data 644-5 may be fed by the processor 612 through one or more mathematical and/or statistical formulas and/or models in accordance with the identifier detection instructions 642-1 to detect and/or identify an insurance policy number (or other data) from an image and/or scan of an insurance card (or other identification document; e.g., utilizing optical character recognition rules), and/or utilize such data as login credentials, as described herein.

In some embodiments, the accident response instructions 642-2 may be operable to cause the processor 612 to process the vehicle data 644-1, sensor data 644-2, threshold data 644-3, contact data 644-4, and/or insurance data 644-5 in accordance with embodiments as described herein. Vehicle data 644-1, sensor data 644-2, threshold data 644-3, contact data 644-4, and/or insurance data 644-5 received via the input device 616 and/or the transceiver device 614 may, for example, be analyzed, sorted, filtered, decoded, decompressed, ranked, scored, plotted, and/or otherwise processed by the processor 612 in accordance with the accident response instructions 642-2. In some embodiments, vehicle data 644-1, sensor data 644-2, threshold data 644-3, contact data 644-4, and/or insurance data 644-5 may be fed by the processor 612 through one or more mathematical and/or statistical formulas and/or models in accordance with the accident response instructions 642-2 to guide a user through an incident/accident claim documentation process by utilizing (i) accident visual documentation rules, accident recorded statement rules (and/or text-to-speech conversion rules), and/or accident diagram rules, as described herein.

According to some embodiments, the accident analysis instructions 642-3 may be operable to cause the processor 612 to process the vehicle data 644-1, sensor data 644-2, threshold data 644-3, contact data 644-4, and/or insurance data 644-5 in accordance with embodiments as described herein. Vehicle data 644-1, sensor data 644-2, threshold data 644-3, contact data 644-4, and/or insurance data 644-5 received via the input device 616 and/or the transceiver device 614 may, for example, be analyzed, sorted, filtered, decoded, decompressed, ranked, scored, plotted, and/or otherwise processed by the processor 612 in accordance with the accident analysis instructions 642-3. In some embodiments, vehicle data 644-1, sensor data 644-2, threshold data 644-3, contact data 644-4, and/or insurance data 644-5 may be fed by the processor 612 through one or more mathematical and/or statistical formulas and/or models in accordance with the accident analysis instructions 642-3 to calculate a likelihood of accident causation and/or assignment of responsibility, calculate an estimated amount of damage, and/or calculate an amount payable in response to an insurance claim submission, as described herein.

In some embodiments, the interface instructions 642-4 may be operable to cause the processor 612 to process the vehicle data 644-1, sensor data 644-2, threshold data 644-3, contact data 644-4, and/or insurance data 644-5 in accordance with embodiments as described herein. Vehicle data 644-1, sensor data 644-2, threshold data 644-3, contact data 644-4, and/or insurance data 644-5 received via the input device 616 and/or the transceiver device 614 may, for example, be analyzed, sorted, filtered, decoded, decompressed, ranked, scored, plotted, and/or otherwise processed by the processor 612 in accordance with the interface instructions 642-4. In some embodiments, vehicle data 644-1, sensor data 644-2, threshold data 644-3, contact data 644-4, and/or insurance data 644-5 may be fed by the processor 612 through one or more mathematical and/or statistical formulas and/or models in accordance with the interface instructions 642-4 to provide the interface 620 (e.g., such as the interface 220, 320, 520a-d of FIG. 2, FIG. 3, FIG. 5A, FIG. 5B, FIG. 5C, and/or FIG. 5D herein) via which input and/or output descriptive of an accident event, scene, response action, and/or result may be captured and/or provided, as described herein.

According to some embodiments, the apparatus 610 may comprise the cooling device 650. According to some embodiments, the cooling device 650 may be coupled (physically, thermally, and/or electrically) to the processor 612 and/or to the memory device 640. The cooling device 650 may, for example, comprise a fan, heat sink, heat pipe, radiator, cold plate, and/or other cooling component or device or combinations thereof, configured to remove heat from portions or components of the apparatus 610.

Any or all of the exemplary instructions and data types described herein and other practicable types of data may be stored in any number, type, and/or configuration of memory devices that is or becomes known. The memory device 640 may, for example, comprise one or more data tables or files, databases, table spaces, registers, and/or other storage structures. In some embodiments, multiple databases and/or storage structures (and/or multiple memory devices 640) may be utilized to store information associated with the apparatus 610. According to some embodiments, the memory device 640 may be incorporated into and/or otherwise coupled to the apparatus 610 (e.g., as shown) or may simply be accessible to the apparatus 610 (e.g., externally located and/or situated).

Referring to FIG. 7A, FIG. 7B, FIG. 7C, FIG. 7D, and FIG. 7E, perspective diagrams of exemplary data storage devices 740a-e according to some embodiments are shown. The data storage devices 740a-e may, for example, be utilized to store instructions and/or data such as the identifier detection instructions 642-1, accident response instructions 642-2, accident analysis instructions 642-3, interface instructions 642-4, vehicle data 644-1, sensor data 644-2, threshold data 644-3, contact data 644-4, and/or insurance data 644-5, each of which is presented in reference to FIG. 6 herein. In some embodiments, instructions stored on the data storage devices 740a-e may, when executed by a processor, cause the implementation of and/or facilitate the method 400 of FIG. 4 herein, and/or portions thereof.

According to some embodiments, the first data storage device 740a may comprise one or more various types of internal and/or external hard drives. The first data storage device 740a may, for example, comprise a data storage medium 746 that is read, interrogated, and/or otherwise communicatively coupled to and/or via a disk reading device 748. In some embodiments, the first data storage device 740a and/or the data storage medium 746 may be configured to store information utilizing one or more magnetic, inductive, and/or optical means (e.g., magnetic, inductive, and/or optical-encoding). The data storage medium 746, depicted as a first data storage medium 746a for example (e.g., breakout cross-section “A”), may comprise one or more of a polymer layer 746a-1, a magnetic data storage layer 746a-2, a non-magnetic layer 746a-3, a magnetic base layer 746a-4, a contact layer 746a-5, and/or a substrate layer 746a-6. According to some embodiments, a magnetic read head 748a may be coupled and/or disposed to read data from the magnetic data storage layer 746a-2.

In some embodiments, the data storage medium 746, depicted as a second data storage medium 746b for example (e.g., breakout cross-section “B”), may comprise a plurality of data points 746b-2 disposed with the second data storage medium 746b. The data points 746b-2 may, in some embodiments, be read and/or otherwise interfaced with via a laser-enabled read head 748b disposed and/or coupled to direct a laser beam through the second data storage medium 746b.

In some embodiments, the second data storage device 740b may comprise a CD, CD-ROM, DVD, Blu-Ray™ Disc, and/or other type of optically-encoded disk and/or other storage medium that is or becomes know or practicable. In some embodiments, the third data storage device 740c may comprise a USB keyfob, dongle, and/or other type of flash memory data storage device that is or becomes know or practicable. In some embodiments, the fourth data storage device 740d may comprise RAM of any type, quantity, and/or configuration that is or becomes practicable and/or desirable. In some embodiments, the fourth data storage device 740d may comprise an off-chip cache such as a Level 2 (L2) cache memory device. According to some embodiments, the fifth data storage device 740e may comprise an on-chip memory device such as a Level 1 (L1) cache memory device.

The data storage devices 740a-e may generally store program instructions, code, and/or modules that, when executed by a processing device cause a particular machine to function in accordance with one or more embodiments described herein. The data storage devices 740a-e depicted in FIG. 7A, FIG. 7B, FIG. 7C, FIG. 7D, and FIG. 7E are representative of a class and/or subset of computer-readable media that are defined herein as “computer-readable memory” (e.g., non-transitory memory devices as opposed to transmission devices or media).

### VI. Terms and Rules of Interpretation

Throughout the description herein and unless otherwise specified, the following terms may include and/or encompass the example meanings provided. These terms and illustrative example meanings are provided to clarify the language selected to describe embodiments both in the specification and in the appended claims, and accordingly, are not intended to be generally limiting. While not generally limiting and while not limiting for all described embodiments, in some embodiments, the terms are specifically limited to the example definitions and/or examples provided. Other terms are defined throughout the present description.

Some embodiments described herein are associated with a “user device” or a “network device”. As used herein, the terms “user device” and “network device” may be used interchangeably and may generally refer to any device that can communicate via a network. Examples of user or network devices include a PC, a workstation, a server, a printer, a scanner, a facsimile machine, a copier, a PDA, a storage device (e.g., a disk drive), a hub, a router, a switch, and a modem, a video game console, or a wireless phone. User and network devices may comprise one or more communication or network components. As used herein, a “user” may generally refer to any individual and/or entity that operates a user device. Users may comprise, for example, customers, consumers, product underwriters, product distributors, customer service representatives, agents, brokers, etc.

As used herein, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As used herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately and/or specially-programmed computers and/or computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

### VII. Conclusion

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

It will be understood that various modifications can be made to the embodiments of the present disclosure herein without departing from the scope thereof. Therefore, the above description should not be construed as limiting the disclosure, but merely as embodiments thereof. Those skilled in the art will envision other modifications within the scope of the invention as defined by the claims appended hereto.

What is claimed is:

1. A system for automatic accident analysis, comprising:
a web server; and
an electronic processing server in communication with the web server, comprising:
a plurality of data processing units; and
a non-transitory memory device in communication with the plurality of data processing units and storing (i) optical character recognition rules, (ii) text-to-speech conversion rules, (iii) accident visual documentation rules, (iv) accident recorded statement rules, (v) accident diagram rules, (vi) graphical user interface generation rules, and (vii) instructions that when executed by the plurality of data processing units result in:
receiving, by the web server and from a mobile electronic device disposed at an accident scene, a request for an accident analysis webpage;
serving, by the web server and to the mobile electronic device, and utilizing the graphical user interface generation rules, the accident analysis webpage, wherein the accident analysis webpage comprises (i) instructions requesting that the mobile electronic device be utilized to capture an image of an insurance card, and (ii) a first command to automatically activate a camera of the mobile electronic device;
receiving, by the web server and from the mobile electronic device, and in response to the serving of the accident analysis webpage, the image of the insurance card;
identifying, by the electronic processing server and utilizing the optical character recognition rules applied to the image of the insurance card, an insurance policy identifier;
retrieving, by the electronic processing server from a database, and utilizing the insurance policy identifier, (i) a listing of insured vehicles on the insurance policy, (ii) a listing of drivers on the insurance policy, and (iii) contact information for the insurance policy;
serving, by the web server and to the mobile electronic device, and utilizing the graphical user interface generation rules, an insurance policy details confirmation page, wherein the insurance policy details confirmation page comprises a pre-filled drop-down menu populated with at least one of the listing of insured vehicles on the insurance policy and the listing of drivers on the insurance policy;
receiving, by the web server and from the mobile electronic device, and in response to the serving of the insurance policy details confirmation page, (i) an indication of a selection of an option from the at least one of the listing of insured vehicles on the insurance policy and the listing of drivers on the insurance policy and (ii) an indication of a verification of the contact information for the insurance policy; and
accepting the verification of the contact information for the insurance policy as an access credential for at least one of the (i) accident visual documentation rules, (ii) accident recorded statement rules, and (iii) accident diagram rules.

2. The system of claim 1, wherein the instructions, when executed by the plurality of data processing units, further result in:
serving, after the accepting and by the web server and to the mobile electronic device, and utilizing the graphical user interface generation rules, an accident image capture webpage, wherein the accident image capture webpage comprises (i) instructions requesting that the mobile electronic device be utilized to capture a plurality of specific images of the accident scene in accordance with the accident visual documentation rules, and (ii) a second command to automatically activate the camera of the mobile electronic device;
receiving, by the web server and from the mobile electronic device, and in response to the serving of the accident image capture webpage, a first image of the accident scene;
determining, by the electronic processing server and utilizing the optical character recognition rules applied to the first image of the accident scene, that the first image of the accident scene complies with the accident visual documentation rules that define a required characteristic of the first image of the accident scene;
transmitting, after the determining and by the web server and to the mobile electronic device, a third command to automatically activate the camera of the mobile electronic device; and
receiving, by the web server and from the mobile electronic device, and in response to the transmitting of the third command to automatically activate the camera of the mobile electronic device, a second image of the accident scene.

3. The system of claim 1, wherein the instructions, when executed by the plurality of data processing units, further result in:
serving, after the accepting and by the web server and to the mobile electronic device, and utilizing the graphical user interface generation rules, an accident image capture webpage, wherein the accident image capture webpage comprises (i) instructions requesting that the mobile electronic device be utilized to capture a plurality of specific images of the accident scene in accordance with the accident visual documentation rules, and (ii) a second command to automatically activate the camera of the mobile electronic device;
receiving, by the web server and from the mobile electronic device, and in response to the serving of the accident image capture webpage, a first image of the accident scene;
determining, by the electronic processing server and utilizing the optical character recognition rules applied to the first image of the accident scene, that the first image of the accident scene fails to comply with the accident visual documentation rules that define a required characteristic of the first image of the accident scene;
transmitting, after the determining and by the web server and to the mobile electronic device, (a) instructions indicating why the first image of the accident scene fails to comply with the accident visual documentation rules that define the required characteristic of the first image of the accident scene and (b) a third command to automatically activate the camera of the mobile electronic device; and
receiving, by the web server and from the mobile electronic device, and in response to the transmitting of the third command to automatically activate the camera of the mobile electronic device, a second version of the first image of the accident scene.

4. The system of claim 1, wherein the instructions, when executed by the plurality of data processing units, further result in:
serving, after the accepting and by the web server and to the mobile electronic device, and utilizing the graphical user interface generation rules, a recorded statement webpage, wherein the recorded statement webpage comprises (i) instructions requesting that the mobile electronic device be utilized to record a statement in accordance with the accident recorded statement rules, and (ii) a first command to automatically activate a microphone of the mobile electronic device;
receiving, by the web server and from the mobile electronic device, and in response to the serving of the recorded statement webpage, a first portion of recorded audio;
determining, by the electronic processing server and utilizing the text-to-speech conversion rules applied to the first portion of recorded audio, that the first portion of recorded audio complies with the accident recorded statement rules defining a required characteristic of the first portion of recorded audio;
transmitting, after the determining and by the web server and to the mobile electronic device, a second command to automatically activate the microphone of the mobile electronic device; and
receiving, by the web server and from the mobile electronic device, and in response to the transmitting of the second command to automatically activate the microphone of the mobile electronic device, a second portion of recorded audio.

5. The system of claim 1, wherein the instructions, when executed by the plurality of data processing units, further result in:
serving, after the accepting and by the web server and to the mobile electronic device, and utilizing the graphical user interface generation rules, a recorded statement webpage, wherein the recorded statement webpage comprises (i) instructions requesting that the mobile electronic device be utilized to record a statement in accordance with the accident recorded statement rules, and (ii) a first command to automatically activate a microphone of the mobile electronic device;
receiving, by the web server and from the mobile electronic device, and in response to the serving of the recorded statement webpage, a first portion of recorded audio;
determining, by the electronic processing server and utilizing the text-to-speech conversion rules applied to the first portion of recorded audio, that the first portion of recorded audio fails to comply with the accident recorded statement rules defining a required characteristic of the first portion of recorded audio;
transmitting, after the determining and by the web server and to the mobile electronic device, (a) instructions indicating why the first portion of recorded audio fails to comply with the accident recorded statement rules that define the required characteristic of the first portion of recorded audio and (b) a second command to automatically activate the microphone of the mobile electronic device; and
receiving, by the web server and from the mobile electronic device, and in response to the transmitting of the second command to automatically activate the microphone of the mobile electronic device, a second version of the first portion of recorded audio.

6. The system of claim 1, wherein the instructions, when executed by the plurality of data processing units, further result in:
serving, after the accepting and by the web server and to the mobile electronic device, and utilizing the graphical user interface generation rules, an accident diagram webpage, wherein the accident diagram webpage comprises (i) instructions requesting that the mobile electronic device be utilized to construct a diagram of the accident scene in accordance with the accident diagram rules, and (ii) a map-based diagram tool comprising a pre-loaded geo-referenced map of the accident scene and at least one GUI vector drawing tool;
receiving, by the web server and from the mobile electronic device via the GUI vector drawing tool, and in response to the serving of the accident diagram webpage, a first vector input defining (a) a first location on the map and (b) a first direction on the map.

7. The system of claim 6, wherein the accident diagram webpage further comprises (iii) a common GUI object selection tool, and wherein the instructions, when executed by the plurality of data processing units, further result in:
receiving, by the web server and from the mobile electronic device via the GUI object selection tool, and in response to the serving of the accident diagram webpage, a first GUI object selection input defining (a) a first one of a plurality of available GUI objects and (b) a second location on the map.

8. The system of claim 7, wherein the instructions, when executed by the plurality of data processing units, further result in:
calculating a difference between the first and second locations on the map; and
determining, by applying stored proximity threshold rules, that the first and second locations on the map are within a predetermined proximity threshold.

9. The system of claim 8, wherein the instructions, when executed by the plurality of data processing units, further result in:
creating, based on the determining that the first and second locations on the map are within a predetermined proximity threshold, a spatial data relationship between the first direction on the map and the first one of the plurality of available GUI objects.

10. The system of claim 6, wherein the instructions, when executed by the plurality of data processing units, further result in:
identifying, within the pre-loaded geo-referenced map of the accident scene, a subset of areas that correspond to locations of vehicle travel;
determining that the first location on the map falls outside of the subset of areas that correspond to locations of vehicle travel; and
transmitting, after the determining that the first location on the map falls outside of the subset of areas that correspond to locations of vehicle travel and to the mobile electronic device, instructions indicating that the first vector input fails to correspond to the subset of areas of the that correspond to locations of vehicle travel in the pre-loaded geo-referenced map of the accident scene.

11. The system of claim 6, wherein the instructions, when executed by the plurality of data processing units, further result in:
identifying, within the pre-loaded geo-referenced map of the accident scene, at least one characteristic of vehicle travel for a subset of areas that correspond to locations of vehicle travel;
determining that the first direction of the first vector input conflicts with the at least one characteristic of vehicle travel for the subset of areas that correspond to locations of vehicle travel; and
transmitting, after the determining that the first direction of the first vector input conflicts with the at least one characteristic of vehicle travel for the subset of areas that correspond to locations of vehicle travel and to the mobile electronic device, instructions indicating that the first vector input conflicts with the at least one characteristic of vehicle travel for the subset of areas that correspond to locations of vehicle travel.

12. The system of claim 6, wherein the instructions, when executed by the plurality of data processing units, further result in:
generating, utilizing the first vector input, a virtual accident scene model; and
calculating, based on the virtual accident scene model and stored virtual accident scene analysis rules, a virtual result of the accident.

13. The system of claim 12, wherein the calculating of the virtual result of the accident, comprises:
computing, based on mathematical analysis of the virtual accident scene, an estimated extent of damage incurred during the accident; and
computing, based on the estimated extent of damage incurred, an estimated cost of repair.

14. The system of claim 13, wherein the calculating of the virtual result of the accident, further comprises:
computing, based on the estimated cost of repair and stored information descriptive of the insurance policy, an estimated claim coverage amount.

15. The system of claim 12, wherein the calculating of the virtual result of the accident, comprises:
computing, based on mathematical analysis of the virtual accident scene, a likelihood of a particular vehicle operator being at fault.
